(19) United States
(12) Patent Application Publication
(10) Pub. No.: US 2010/0114702 A1
(43) Pub. Date: May 6, 2010

(54) ASK/RESPOND AFFINITY GROUP REFERRAL METHOD AND APPARATUS

(76) Inventors: Arthur WU, San Francisco, CA (US); Justin Lin, San Francisco, CA (US); Kenneth Miller, Albany, CA (US); Mary McBride, San Francisco, CA (US); Julie D'Agostino, San Francisco, CA (US); Aaron Cohen, Sausalito, CA (US); Derek Greenberg, Pleasanton, CA (US); Steven Ketchpel, Foster City, CA (US); Sarah Diego, Kensington, CA (US); Todd Werth, San Francisco, CA (US)

Correspondence Address: GLENN PATENT GROUP, 3475 EDISON WAY, SUITE L, MENLO PARK, CA, 94025, US

(21) Appl. No.: 12/611,059

(22) Filed: Nov. 2, 2009

Related U.S. Application Data
(63) Continuation-in-part of application No. 11/531,644, filed on Sep. 13, 2006.

(51) Int. Cl. G06Q 99/00; G06Q 30/00; G06Q 50/00; G06F 3/048; G06F 15/16

(52) U.S. Cl. 705/14.53; 705/319; 715/753

(57) ABSTRACT

An ask/respond affinity group referral method and apparatus comprises a community of individuals having an implied social contract, where the individuals are affiliated with each other to provide assistance and help to each other. In such community, the individuals do not know each other, but are joined together to help each other around a common interest. In such community, any individual may ask everybody else a question and the others can each respond. The community is specifically directed to mothers in every phase of their relationship, i.e. grandmothers, single mothers, mothers with husbands in Iraq, mothers with children, mothers without children, et cetera and is, therefore, directed to all kinds of phases and special needs of mothers. An interactive timeline tool serves to record information about their children, to anticipate future child development needs, and to collaborate with other members of the ask/respond affinity group having similar parenting experiences.

### CROSS REFERENCE TO RELATED APPLICATIONS

This application is a continuation-in-part of U.S. patent application Ser. No. 11/531,644 entitled “Ask/respond affinity group referral method and apparatus”, filed Sep. 13, 2006, which is incorporated herewith in its entirety by the reference thereto.

### THE BACKGROUND OF THE INVENTION

1. Technical Field

The invention relates to social interaction over an electronic network. More particularly, the invention relates to an ask/respond affinity group referral method and apparatus.

2. Description of the Prior Art

As electronic communications evolve beyond the current web search and webpage type interaction to a more social model, it is necessary to design social contract and social engineering aspects for governing the interaction of individuals in such electronic environments. Currently, search engines are provided by such companies as Google, which collects information about webpages and provides this information in response to search queries. With such search engine, there is no social contract.

Another form of art exists that could be referred to as a community, such as Epinions, where a website proprietor pays or incentivizes people to write reviews on various products and services. Thereafter, an individual seeking information about the product or service in question can read the review. This is often referred to as the “publish and share” or “share and find” model, where somebody shares information and somebody else comes along and finds the information.

A further model is necessary if satisfying social interactions are to be obtained. It would therefore be advantageous to provide in an electronic communications medium social contract and social engineering aspects within a community of individuals organized around a common interest or purpose.

### SUMMARY OF THE INVENTION

The invention provides an ask/respond affinity group referral method and apparatus. The ask/respond model comprises a community of individuals with an implied social contract and where the individuals are affiliated with each other to provide assistance and help to each other. In such community, the individuals do not know each other, but are joined together to help each other around a common interest. In such community any individual may ask everybody else a question to which the others can respond. The community described herein is specifically directed to mothers in every phase of their relationship, i.e. grandmothers, single mothers, mothers with husbands in Iraq, mothers with children, mothers without children, et cetera. The community is, therefore, directed to all kinds of phases and special needs of mothers. Those skilled in the art will appreciate that, while the embodiment of the invention herein is directed to mothers, the invention described herein may be applied to other communities.

In the disclosed invention, when one mother asks a question the invention provides a system that routes the question to the right set of mothers in a manner that evokes the highest amount of empathy, as measured by common interests, family situations, propensity to reply, geography, etc. The mothers receiving the message respond to the mother asking the question. The questions themselves, as well as the responses, are informational in part and empathetic in part. Thus, in many cases, while the mother is asking for advice, basically they are reaching out for support or assistance. In many cases there are no right answers, but the response of the community provides support and assists the mother in resolving the issue confronting her.

The invention thus provides a framework for a community based upon an ask/respond affinity group referral method and apparatus. The invention, in a further embodiment, also provides a mechanism for monetizing such service.

In some embodiments, the invention provides members of the ask/respond affinity group with one or more interactive timeline to record information about their children, to anticipate future child development needs, and to collaborate with other members of the ask/respond affinity group having similar parenting experiences.

### BRIEF DESCRIPTION OF THE DRAWINGS

FIG. 1 is a block schematic diagram of an ask/respond affinity group referral system according to the invention;

FIG. 2a is an architectural overview of an ask/respond affinity group referral system according to the invention;

FIG. 2b is an architectural diagram of an ask/referral affinity group referral system incorporating a circle ratings feature according to the invention;

FIG. 3 is a webpage showing a homepage for an ask/respond affinity group referral service;

FIG. 4 is a webpage showing a profile form for an ask/respond affinity group referral service;

FIG. 5 is a webpage showing a user profile for an ask/respond affinity group referral service;

FIG. 6 is a webpage showing an invitation for an ask/respond affinity group referral service;

FIG. 7 is a webpage showing actions that may be taken in a shared directory for an ask/respond affinity group referral service;

FIG. 8 is a webpage showing an ask form for an ask/respond affinity group referral service;

FIGS. 9a and 9a are webpages showing a respond form for an ask/respond affinity group referral service;

FIGS. 10a and 10b are webpages showing a shared directory for an ask/respond affinity group referral service;

FIG. 11 is a webpage showing a shared referral form for an ask/respond affinity group referral service;

FIG. 12 is a webpage showing a request for an ask/respond affinity group referral service;

FIG. 13 is a webpage showing a listing of past requests in an ask/respond affinity group referral service;

FIG. 14 is a webpage showing a member directory for an ask/respond affinity group referral service;

FIGS. 15a and 15b are webpages showing an inbox showing sent requests in an inbox for an ask/respond in a group referral service;

FIG. 16 is a webpage showing an inbox for requests in an ask/respond affinity group referral service;

FIG. 17 is webpage showing an inbox for response in an ask/respond affinity group referral service;

FIG. 18 is a webpage of an inbox showing referrals in ask/respond affinity group referral service;

FIG. 19 is a webpage for an inbox showing questions on referrals in an ask/respond affinity group referral service;

FIG. 20 is a webpage showing an inbox with thank you notes in an ask/respond affinity group referral service;

FIG. 21 is a webpage having a “so what happened” feature;

FIG. 22A is a representation of an interactive timeline interface populated with milestones for the child of user according to some embodiments of the invention;

FIG. 22B is a representation of a pop-up window for adding new milestones to the interactive timeline interface according to some embodiments of the invention;

FIG. 23 is a representation of an interactive timeline interface populated with community member-posted topics relevant to a user's child according to some embodiments of the invention;

FIG. 24A is a representation of an alternative interactive timeline interface with a plurality of menus and windows for navigating common issues relating to child development according to some embodiments of the invention;

FIG. 24B is a representation of an alternative interactive timeline interface with a topical balloon menu for navigating common issues relating to child development according to some embodiments of the invention; and

FIG. 25 illustrates a schematic representation of a timeline manager for providing an ask/respond affinity group with timeline services over a distributed network according to some embodiments of the invention.

### DETAILED DESCRIPTION OF THE INVENTION

The invention provides an ask/respond affinity group referral method and apparatus. The ask/respond model comprises a community of individuals with an implied social contract and where the individuals are affiliated with each other to provide assistance and help to each other. In such community, the individuals do not know each other, but are joined together to help each other around a common interest. In such community, any individual may ask everybody else a question to which the others can respond. The community described herein is specifically directed to mothers in every phase of their relationship, i.e. grandmothers, single mothers, mothers with husbands in Iraq, mothers with children, mothers without children, et cetera. The community is, therefore, directed to all kinds of phases and special needs of mothers. Those skilled in the art will appreciate that, while the embodiment of the invention herein is directed to mothers, the invention described herein may be applied to other communities.

In the disclosed invention, when one mother asks a question the invention provides a system that routes the question to the right set of mothers in a manner that evokes the highest amount of empathy, as measured by common interests, family situations, propensity to reply, geography, etc. The mothers receiving the message respond to the mother asking the question. The questions themselves, as well as the responses, are informational in part and empathetic in part. Thus, in many cases, while the mother is asking for advice, basically they are reaching out for support or assistance. In many cases there are no right answers, but the response of the community provides support and assists the mother in resolving the issue confronting her.

The invention thus provides a framework for a community based upon an ask/respond affinity group referral method and apparatus. The invention in a further embodiment, also provides a mechanism for monetizing such service.

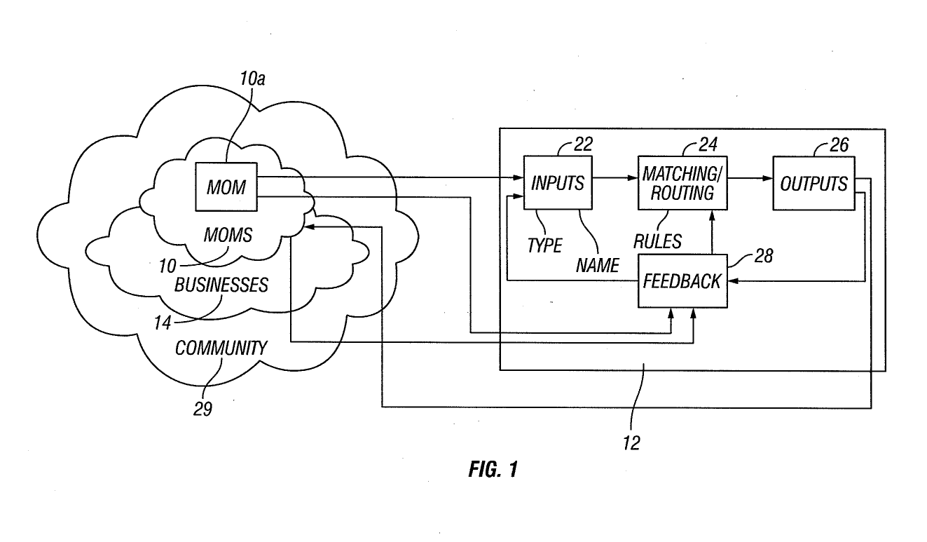

FIG. 1 is a block schematic diagram of ask/respond affinity group referral system according to the invention. The ask/respond affinity system of the invention operates in the community 29. The invention is primarily concerned with moms in the community 10 and, a further embodiment, is concerned business in the community 14. The system includes an ask/respond engine 12. In FIG. 1, the ask/respond engine is shown receiving inputs 22, and in the example of FIG. 1 from a mom 10a. The inputs are both of a type and nature. For example, the inputs may be information about the mom, a local area, a business, or it may be a request. The nature of these inputs, for example, with regard to a mom might include geographic information such as the location of where the mom lives, age of the mom's children and other demographic information, past activity of the mom, for example volume of interaction with the system, type of interaction, for example whether the mom is an author or communicator, the content categories that the mom participates in, the businesses rated, the quality of the mom's participation as indicated by such factors as how often her postings are read, bookmarked, and how often she receives thank you's for her participation, as well as other types of feedback, the source of acquisition of the mom, the declared interests and tags of the mom, and a satisfaction score of the mom, also referred to as an NP score, and whether the mom is a new or recent member; with regard to the local area type the nature might conclude the number of approximate local members, prior traffic and prior referral ratios; with regard to requests, the nature of requests can concern such factors as the category, potential for high empathy, whether it is a first request from a member, the number of the replies and rate received, whether the requests is locally constrained and the like.

The inputs of the input module 42 are applied to a matching and a routing module 24 which operates in accordance to various roles. For example with regard to routing, the rules might influence the routing of a request or response based on the ordering of requests on the site, what is featured, what is in a digest, what is sent in individual emails, what may be forwarded to non-members, and the like. The matching/routing module produces outputs 26 which are routed back to the community and ultimately to the other moms in the ask/respond affinity group. Additionally, the outputs are provided to a feedback element 28 which serves to adapt the operation of matching/routing aspect of the ask/respond engine, as well as providing additional inputs to the input system. Further feedback may be perceived the moms which also serve to adapt the operation of the algorithms within the system. Finally, a mom making a request herself may provide feedback, such as sending a flower to mom who sends a response (as discussed below).

The feedback in the matching/routing module cooperate based on inputs of the system to maximize satisfaction of users in the system which may be evidenced by such factors as the number of replies to requests, the usage of a site, and the rate at which new members are invited into the system. The system generates replies to requests which may be informational or emphatic. The empathy itself may be explicit, such as expressions of sympathy or understanding, or implicit such as useful information.

In an exemplary embodiment of the invention, the routing aspect of the matching/routing module 24 implements various algorithms to accomplish this routing. For example:

If the mom is put on a watch list or otherwise notified as service provider, i.e. the mom refers the same business listing four or five times, then the mom would no longer see questions in her category i.e. plumbers would not see plumbing requests, in which case a highly rated mom would be found anyway. This should reduce trolling for leads and protect the donations coming in (see the discussion below).

The invention can apply different rule sets by size of the geographic group and by population density. This is important because in the geographic group that has only 10 moms, it may be necessary for everybody to see everything regardless of relevance just to have sufficient interaction and keep the group going. If there are only 10 in the group they are more likely to want to connect as well and have some excuse to strike up a conversation. As the geographic groups gets to be more medium size, the requests and interactions become more about moms forming mini clusters in their three to five mile bands, age bands, interest bands and by routing, but the invention is primarily concerned with getting moms connected with someone who will try to help them. Thus, the engine itself is adaptive and the rules are set for this purpose. As the geographic area gets very large, the concerns of the invention are more about bastardization, the precise routing of messages, and making sure the system naturally routes to create mini dimensions of mini categories by location, age, and interest. The size of geographic group is also influenced by population density. Thus, geographic radius thresholds may be more relaxed in less densely populated areas such as New Mexico than in a densely populated areas such as New York City.

Rules may also be used to show moms other relevant moms i.e. not just matching mom's requests, but also matching moms with moms. For example the rules may match moms to moms who have asked or replied to questions in a particular category, to other moms near them, e.g. within two miles, other families with kids of the same age. There may also be matching to moms who are implicitly near each other, for example matching family with multiple kids with the same age combination, i.e. families with a four year old are a lot easier to find than a family with exactly two, five and seven years old.

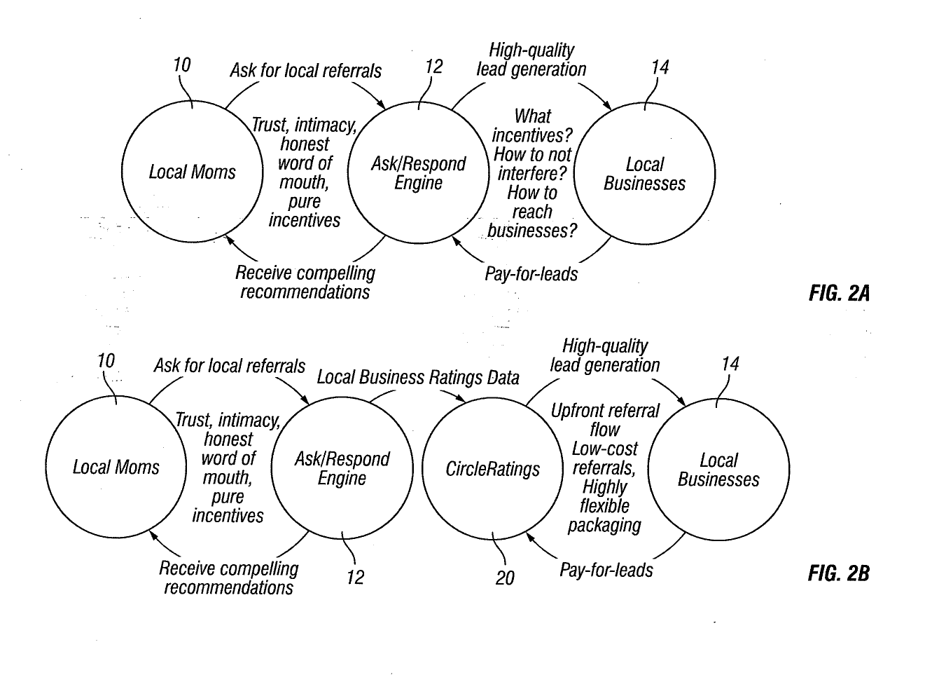

FIG. 2a is an architectural overview of an ask/respond affinity group referral system according to the invention. In FIG. 2a, a social group consisting of local moms 10 is engaged with an ask/respond engine 12, as discussed in detail below. The local moms ask for local referrals, for example for a particular business service or product. The moms receive compelling recommendations based on responses provided by other moms. A key value component of the invention is the trust/intimacy/honest word of mouth content of the information, as well as incentives that are based on integrity. These aspects of the invention are discussed in further detail below. The ask/respond engine 12, in turn, provides information to local businesses 14. Thus, the local moms, by making referrals, generate high quality leads for local businesses. To monetize the service, which is provided for free to the local moms in one embodiment, the local businesses pay for leads, as is discussed in greater detail below. The invention addresses the type of incentives, how not to interfere with the community of local moms, and how to reach the appropriate businesses.

The invention provides both a service or product dimension and an empathy dimension. The question asked by a mom could be something as simple as an individual facing a phase in their life that may be difficult, where the query is routed to somebody who is in a similar situation or who has dealt with that situation before, such that the mother querying the group receives advice back that might help comfort her. The preferred embodiment of the invention provides three components of information. The first component is the actual information, such as a referral to a plumber, or a method on handling diaper rash. The second component is empathy. For example, an individual may receive an answer from an individual who states they do not know the answer, but they wanted the individual to know that they understand the situation and they support the person and that they have been through that situation before. This type of response is of considerable value in providing support for an individual who may be in a stressful or worrisome situation. Thus, for this component of the invention, algorithms that provide routing and community are built into the system. The third aspect of information is allowing an individual to find someone to connect with offline, for example to form a playgroup or a book club. In contrast to prior art social networking technology, the invention is not a social network because the invention does not introduce the user to a friend or friends. Rather, the invention provides a way for complete strangers to be brought together based on proprietary algorithms of empathetic match/adaptive algorithms. In this regard, the invention provides a site that is preferably accessible by invitation only. Thus, an individual is only let in by someone who knows them. However, once an individual is admitted to the network, it is not a “friends” network. Rather, it is a network that routes requests from individuals to the right recipients and that provides replies back. Thus, the invention provides a framework for social interaction, primarily based upon an algorithmically-routed accessible ask/respond model.

The value of information of each of the system clients, i.e. the mothers, is not just in the underlying database or algorithm that provides the routing and matching of information, but the manner in which the social contract is established by the system to bring moms together with other moms. Thus, the invention provides an innovation in the area of social engineering that connects people in a manner that they could not otherwise be connected together. In this way, the invention provides an electronic social environment that allows individuals to exchange empathy, support, and information on a large scale. That is, the preferred embodiment helps a mom find other moms who have the most empathy and helpfulness for any given question. The routing can be based on user characteristics, but is primarily routed on a question level, not a user level. The presently preferred embodiment matches questions to potential responding users; it is not asking users to respond to users. i.e. it is not the mom-version of match.com or other dating site. Rather, the invention matches questions to moms who will be helpful, and who will find it emotionally satisfying to reply.

Because the invention provides a closed community, the invention also provides ways to control the community and prevent predators, advertisers, spammers, and the like from entering the community, as well as determining whether members of the community are helpful or not. For example, one of the things the invention accounts for is the relevance of requests. It has been empirically determined by the inventors that reply rates are highest when moms get replies in their email. The art currently recognizes that email is an impractical or not preferred method of exchanging information because users are burdened by such information. Counter-intuitively the invention provides a routing algorithm that provides requests and responses via email, for example, although other routing methods are applicable to the invention. The routing algorithm is based on the observation that if information is routed properly according to all different aspects, then a specific routing algorithm would change over time, change by phase of life, change by geography and the like. For example, if an individual is looking for childcare in Dallas, a particular type of individual or service would meet the daycare need. In Chicago, the need would be met differently even though the need would be the same.

Thus, one aspect of the invention provides an algorithm for routing that varies by geography. The algorithm is tuned to the specific needs of each mom, each group, each scenario, and each situation. The algorithm assures that the mom who is a potential source of empathy, support, information, to other moms is in an optimal manner. In this way, the invention helps to create a vibrant community that draws otherwise busy mothers in to and engages with the system.

As for the concern of spam discussed above, every member of the community has the ability to block messages. The system automatically pulls posts, when enough moms flag someone or something as spam. Thus, there is no need for a human to monitor the community with regard to spam. Rather, the community polices/moderates itself.

Another aspect of the invention provides that when a mom sends out a message, everything is mediated by the system. In this way, the moms do not have each other's emails, and a level of anonymity is maintained as long as the mother wishes to do so. Thus, all messages go through the system and are filtered at that level, i.e., the invention provides word-filtering. A list of words may be checked to determine if a message contains offensive or blocked information, and the message is not propagated through the system if it is determined from the content that it is restricted. However, if the information comes from a mom and the mom must be registered with the system and logged in to use it, the system knows who the individual is and the individual's past behavior. Thus, if the mom has had any actions against her in the past, such as people blocking her, people blocking her messages, spam, or the like, the system may quarantine the her message, such that it is more difficult for her to post her information into the system. Thus, while individuals exist that may choose to maintain their anonymity with regard to each other, the system itself knows everybody. There is no anonymity as far as the system is concerned. Further, there is no anonymity in terms of the individual's past behavior. The algorithm is adoptive and learns from the interaction of the users in the system.

The invention may be thought of as a means for creating a society, and in that sense it is a search or matching engine that allows moms to find other moms. However, the invention is readily distinguished from the state of the art in that a key purpose of the invention is to establish a society in which empathy is a factor. Thus, it is often more important in the invention that the person posting a request for information receives support or empathy, rather than just information.

The invention provides a routing technique or mechanism that connects the users together in a manner which maintains their privacy and maintains their control over their personal space, including the ability to block message, mark messages as spam, ignore other moms who are not palatable to them, make sure that the things the moms want actually get forwarded to them, all without placing a burden on the user to fill out a significant number of forms.

Because enabling empathy is a key aspect of the invention, it is important that human activities which detract from empathy are controlled, for example criticism should be controlled. Thus, if a mother posts a request for information and receives a critical response, the mother receiving the response has the option to take the discussion private. Thereafter, any criticism leveled at the mom is leveled between the mom and the person releasing the criticism and is not publicly available. Thus, one aspect of the invention allows the users to take their interaction with other users private. Unlike prior online discussions, the invention herein does not provide long drawn-out threads of interaction. For example, when an individual replies to a request, the individual is allowed only one reply. The recipient of the reply can take the reply private, and the interaction can continue in a private space. However, a person may not post more than one reply to a request. Any further engagement between individuals may take place in a private space only if the recipient chooses to continue the discussion.

The algorithm is both an adaptive algorithm and a human-steered and/or automatically-steered algorithm. Inputs to the algorithm include such things as demographics of the mom, e.g. age of the oldest child, number of children, geographic location, and other demographic information. The profession of the mom is of interest as well because certain professions are deemed to have higher empathy than others. So a nanny or a pre-school teacher would be self-selected into a highly empathetic profession. The algorithm also looks at past behavior of a user on the site, what topical categories the user is active in, whether the user has shared a lot of advice and information, e.g. a giver mom, made a lot of requests in parenting issues versus, for example, spiritual/religious issues, et cetera. Thus, the system learns what the mom is interested in from a historical perspective and the overall activity of the mom. A very active mom, e.g. a giver mom, may receive more accolades and thank-you notes from other moms, and may have replies that are longer in length and that are therefore more informative and thoughtful.

The invention contemplates ratings of moms. To assure success for a mom in the community and thereby assure that each mom receives the best possible ratings, the invention contemplates a way of developing the mom as a member of the community. Thus, if a mom sends out a first request as a new member of the community, the system is programmed to provide replies as quickly as possible. For a mom who poses her first question ever and who is otherwise a desirable community member, the message is routed more aggressively than otherwise.

When the request is first made, the system determines to whom the message is to be sent, whether it is to be forwarded to personal email addresses or not, how often to route it, whether to route it locally or nationally to make sure a response is obtained, whether to send it out in a digest with other requests, or to send it out as individual, standing on its own request. Determination is made of the number of moms to send it to and the schedule in which it is sent. The algorithm can also determine whether it should be forwarded to a certain bastion of moms, i.e. moms who are volunteers in the system who provide a higher level of support than a typical mom.

Between the inputs and the outputs the algorithm provides a logic function and applies weightings to various factors as well as accessing probability tables and business rules. For example, if a mom has five children and is located in Dallas, and in the past she has asked good questions and replied well, then her questions are routed, first of all, to moms having many children in Dallas and then to moms who are very active repliers because she's determined to be a good member of the community. Thus, people who participate more and support the community get preferential treatment.

The invention also comprehends the notion of feedback. In the initial phase of the algorithm, a mom broadcasts a message through the system. During the next step, to the mom receives a reply, followed by a dialogue that can continue until resolution. Within the reply there is a sub case of dialogue referred to as “thank you,” e.g. a flower. In the invention there are three forms of “thank you.”

One form allows a mom to send a message to another mom saying, “thank you.”

A second form provides a button on the user interface, referred to for the purposes of this disclosure as a flower, that may be selected by the mom and which automatically sends a flower to the recipient.

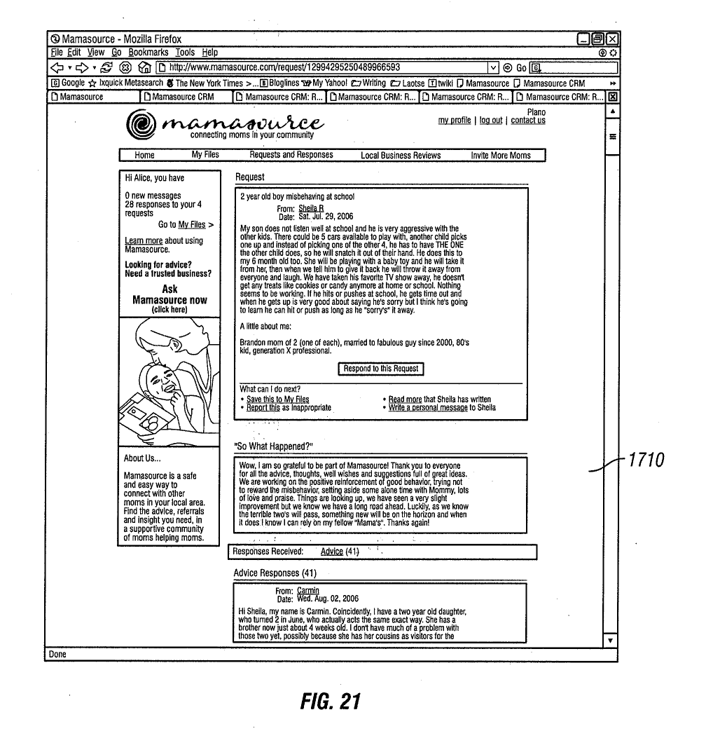

The third case provides a feature called “so what happened.” This feature (see FIG. 21) provides all the replies to a request on a page that is public. A person can review this page and see a referral, a reply, and the action around the request. Thus, an individual browsing the system can see all the action that happened with regard to a certain request. Associated with this display is a box entitled, “so what happened.” By selecting this button, members in the exchange are allowed to provide information with regard to the resolution. For example, if a referral was made to a doctor, the “so what happened” inquiry can be answered with an indication that the doctor was exceptional, or unacceptable, for example. “So what happened” can also be used to give a big group thank you instead of writing notes to individuals.

The invention also contemplates methods for monetizing the provision of the service. FIG. 2b is an architectural diagram of an ask/respond affinity group referral service in which ratings data are used to develop referrals for local businesses. This aspect of the invention concerns the monetization of the service. In FIG. 2b, local moms interact with the ask/respond engine 12 as discussed above in connection with FIG. 1. The ask/respond engine generates local ratings data which are provided in the form of circle ratings 20. Circle ratings produce high quality lead generations for local businesses 14. The invention contemplates an upfront referral flow to local businesses, followed by low cost referrals, in the form of highly flexible packaging. Ultimately, the local businesses pay for leads. This aspect of the invention is discussed in greater detail below.

It is anticipated that the affinity group system is to be provided to the members on a for-free basis. Thus, to support and monetize the system, the system generates customer leads that are sent to local business in the region of each mom's community. One feature of the invention is to create a community of moms. This community of moms, as discussed above, involves high response rates to queries, empathy, and no incentives for participation other than a sense of dedication and loyalty to the community. Thus, this is a true community group where people help each other because of the desire to help each other. There are no incentives for the moms and no cost. They get on the system to help each other, and the point of this feature of the invention is to route the moms to other moms who care about each other.

In terms of monetizing the invention, a first embodiment involves the provision of online ads, where the system proprietor gets paid on a per-click basis. A second embodiment for monetizing the provision of the system concerns the affiliation of the moms in the community. Among these moms, many have children in different local schools and are referring other moms to their favorite local businesses, e.g. contractors, painters, hairdressers, and the like. Because the nature of the community is that of close trust, the referrals are not so much in the form of advertising as trying to help out with good recommendations rated upon experience. Further, the referrals are more likely to be geared toward high value service providers where the amount spent is very high, the relationship is very close, and the risk of making a bad selection is very high. Because the community established by the invention promotes trust and empathy, strangers visiting the site are more likely to trust each other's referrals. Thus, as a mom is helping out other moms through the online community, a set of written documented services is accrued in connection with the mom. It is known whom the mom is, how trusted she is, and how active she is in the community. In this system, to incentivize the mom, very active moms are brought in and, with the mom's permission, the system proprietor provides a feature where any mom who clicks on a review of the mom who is approached, and uses the site to connect with that service, has a donation made to the school that is attended by the mom's children. For example, if a mom has written a review about a local plumber and the plumber is contacted through the service, then a portion of the referral fee from the plumber is directed to the school which the mom's children attend. The more moms that are in the system and making referrals for a particular school, the more that school receives in the way of contributions for the referrals. The incentive to participating moms is to benefit their local community in the form of donations to local schools. While schools are referred to in this example, donations could just as well be made to local churches, or other such community organizations.

The invention also contemplates an extra-net feature in which all of the moms referrals for moms whose children are at a particular school can be put on a particular site, for example the school referral site. Alternatively, the invention puts all the reviews on the school site, even if they were not written by that school's moms, and the school gets credit for any providers that were actually used by its parents. The site is open to the public, and anybody may visit the site for a referral. All referrals generated by that site are used as a basis for generating a donation to the school. Thus, although the invention itself contemplates a private community, the private community supports the notion of a public access site for referrals that generate donations for schools.

The invention thus provides a share of the referral bounty to the school. It is not a case of an individual agreeing to hire, for example, a plumber. Rather, the individual reads reviews and determines that a particular plumber is the one to be contacted based on the quality of the reviews and of the individuals making the reviews. A person can then arrange for the plumber to provide services. If the plumber is contacted through the site, then the referral is sent by the site to the plumber and a portion of the referral fee paid by the plumber is provided to the school.

Thus, a key feature of this aspect of the invention is the use of a closed community to generate a site for a public community automatically. While the funding is provided to schools in this example, it could just as well be provided to charities or other community-related activities. Key to the invention is that the money does not go back to the mom who wrote the reviews and that the mom cannot benefit in any way. This is done to maintain the integrity of the system. The system avoids moral hazard by removing the incentive to provide false or inaccurate information on the part of the members of the community. Further, the reputation of the member is such that a poor referral ultimately reflects poorly on the person making the referral and devalues their opinion and advice in the system. Thus, the invention provides an incentive through a donation mechanism to incent moms to create high quality, truthful, accurate contents in the form of reviews of services and businesses that they care about. Prior to receiving the referral, e.g. a plumber, the referred company pays a standard referral fee which is below typical market price. For example, a plumber might pay a fifteen dollar referral fee, whereas the average referral fee might be fifty dollars.

A key problem in obtaining vendors to whom referrals can be sent is the cost of hiring a sales force to go out and engage in sales of these potential referrals. The invention provides a mechanism for reaching a local service provider and engaging them in a manner that does not require a lot of labor because the community is producing the leads. The system collects these leads in the form of reviews and uses them to create referrals which are sold to vendors. As discussed above, the incentive for individuals within the system to create reviews and comment on reviews is the donations, for example, to the schools of the children attended by the mothers. Other benefits may be provided, such as free premium memberships that allow the user to access more information on the site.

To bring a vendor into the system, based on reviews, the system proprietor does not call vendor. Rather, a vendor just starts receiving leads, for example, by automated phone, FAX, or email. The leads are quality leads and they are provided for free initially, with no registration or other fee, or any other prerequisite.

The first phase of the vendor education process provides free leads to educate the vendor as to how the system works for them. In a second phase, the next few leads sent to the vendor are free as well, but the vendor must come to the system site and confirm contact information, i.e. register. Otherwise the system stops sending leads to the vendor. At a third level, the vendor must pay for the leads. A referral is sent to the vendor, but without the actual contact information for the customer. The vendor can pay an a la carte fee for those leads that he desires to pursue. Thus, the vendor does not have to pay for every lead he gets, there is no subscription, and there is no contract.

In the past there has been no model where people send bona fide leads to vendors without obligation. However, the community established by the invention provides the ability to refer these leads. Over time, the quality of the vendors will be reported by members of the community. The cooperation of the vendors and the quality of work provided is reflected in the weighting provided to them and in their ability to receive continued referrals, as well as the level of recommendation offered to them by the system. The community reinforces the desire of the community members to continue working through the community and not circumvent the community and work directly with vendors outside the system. Clearly, members of the community would like to see their children's school continue to receive donations, for example. Also, vendors would like to receive positive leads from the community and would not have an incentive to circumvent the community in that regard either.

As mentioned above, the system is monetized through referrals to services. The referrals may also be to stores. For example, a local mom in the community can approach a store and obtain advertising, a portion of the fees for which would be returned to the school the mom's children attend.

Because some members of the community are more active than others, it is important to reward and incent them. Because the community herein is based on empathy, such superficial rewards as spa days, or gift certificates, which deal with prestige are considered to be of less importance as an incentive. Thus, the invention contemplates an angel program for the most giving members of the community in which a percentage of the advertising revenue in that community could be distributed by the angel mom for projects within the community. For example, that mom is given a fund that she could use to benefit the community, for example, with regard to funding children's shelters, battered women's shelters, churches, and the like. In this regard, the algorithm observes the behaviors of moms and helps select angel moms on the basis of contribution to the community by the mom. As for dispersing funds by the angel mom, this matter may be left up to the discretion of the angel mom, or may be subject to a vote of the community.

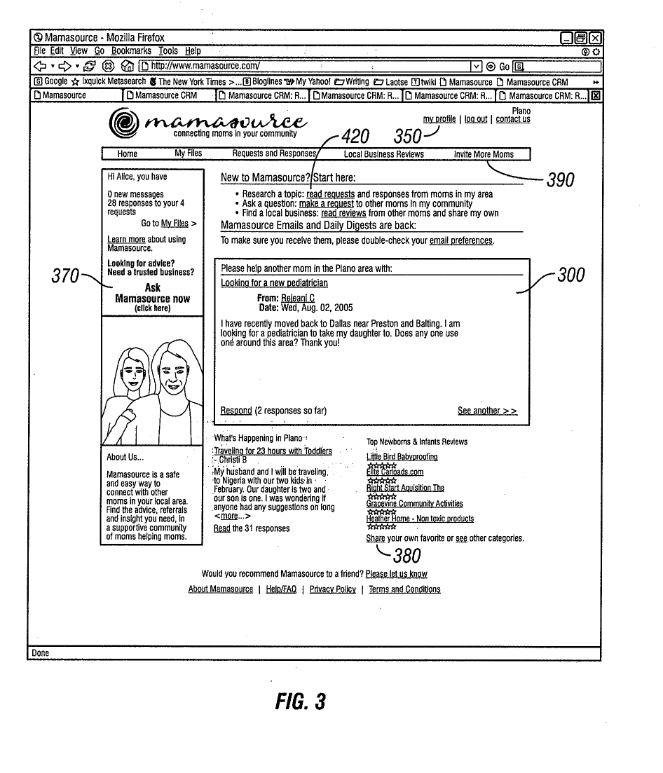

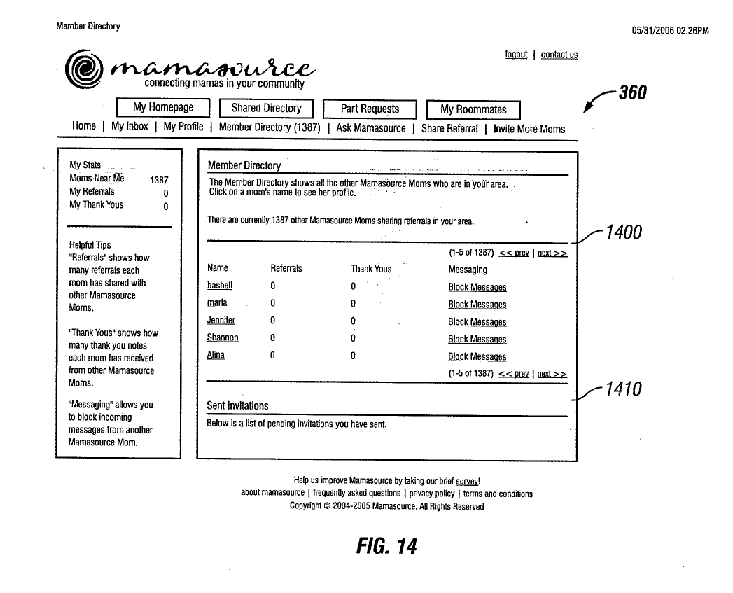

FIG. 3 is a screen shot of a website showing an ask/respond affinity group referral system which is, in this case, referred to as Mamasource. The homepage directs the mother to various features of the referral website. In particular, the mom is provided with an inbox 340, profile 350, a member directory 360 (see FIG. 14), an ask feature 370, a share referral feature 380, and an invitation feature 390. The individuals are all provided with their own homepage, a shared directory 410, for example, (see FIG. 7), a list of past requests 420, and a list of bookmarks. The homepage provides statistics for the mom, such as mothers that live near the mom, referrals, and thank you's that are sent. Finally in addition to some information and news, the invention indicates open requests on Mamasource that have been routed to the mom 300, recent referrals to Mamasource in the community, and new Mamasource moms who have moved into the community. Those skilled in the art will appreciate that this embodiment of the invention is provided for purposes of illustration and example, and that other features may be added, less than all of the shown features may be provided, and that the community may consist of individuals other than moms.

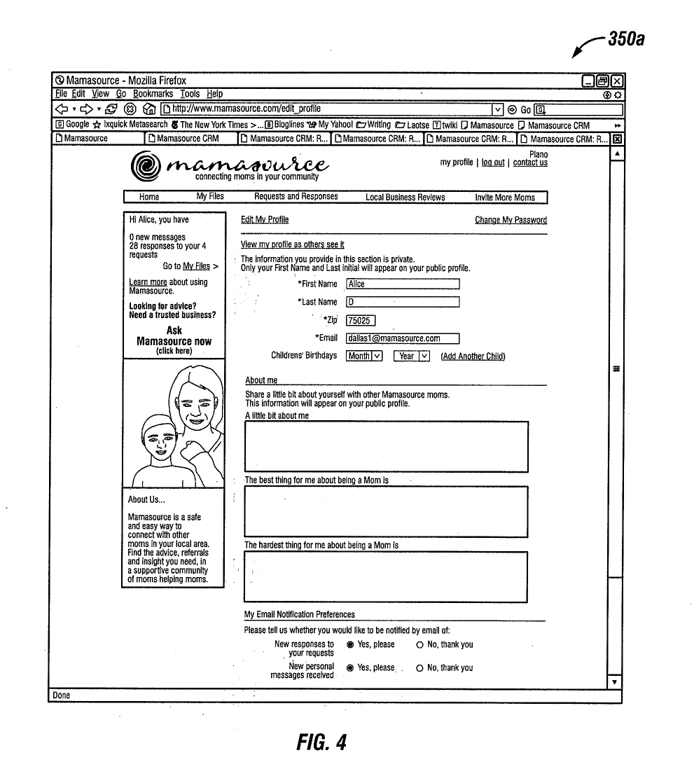

FIG. 4 is a screen shot of a website for an ask/respond affinity group referral system showing a form for creating a user profile 315a. While the profile contains certain information about the mom, the mom is also able to establish parameters for searches that may be forwarded to her email address. As discussed above, this system provides communication through email, although other forms of communication may be provided. In the case of the mom's profile, a mom may identify both the types of information that may be sent to her and who may have access to her profile.

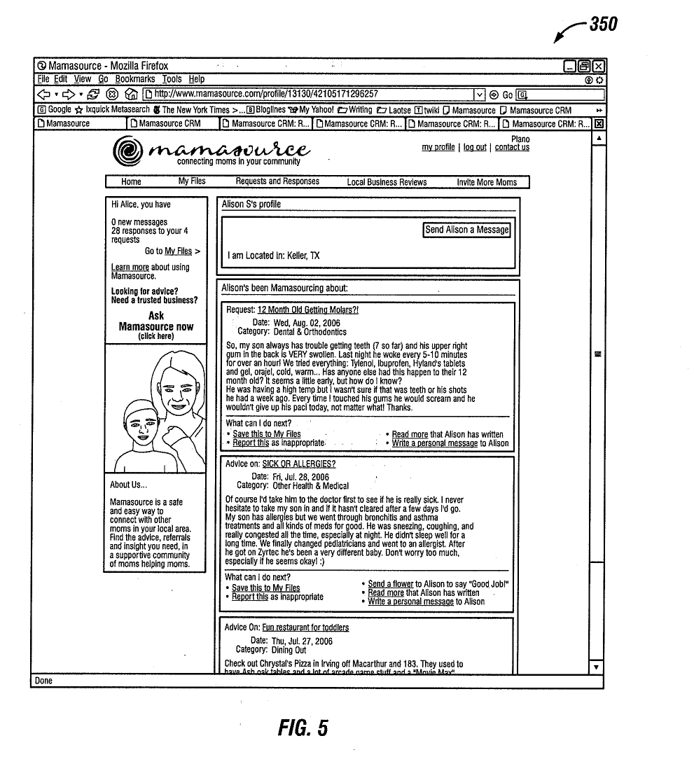

FIG. 5 is screen shot of a website for an ask/respond affinity group referral system showing a completed mom profile 350.

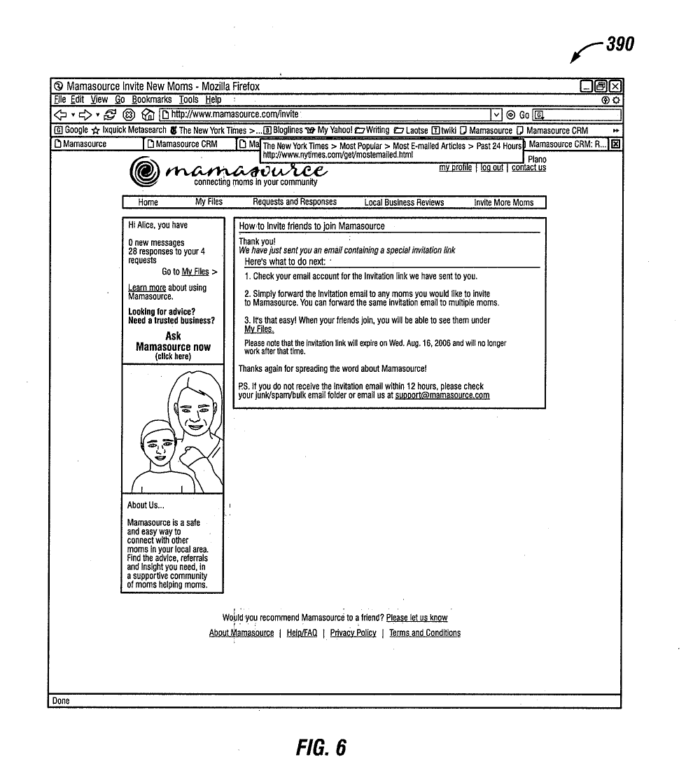

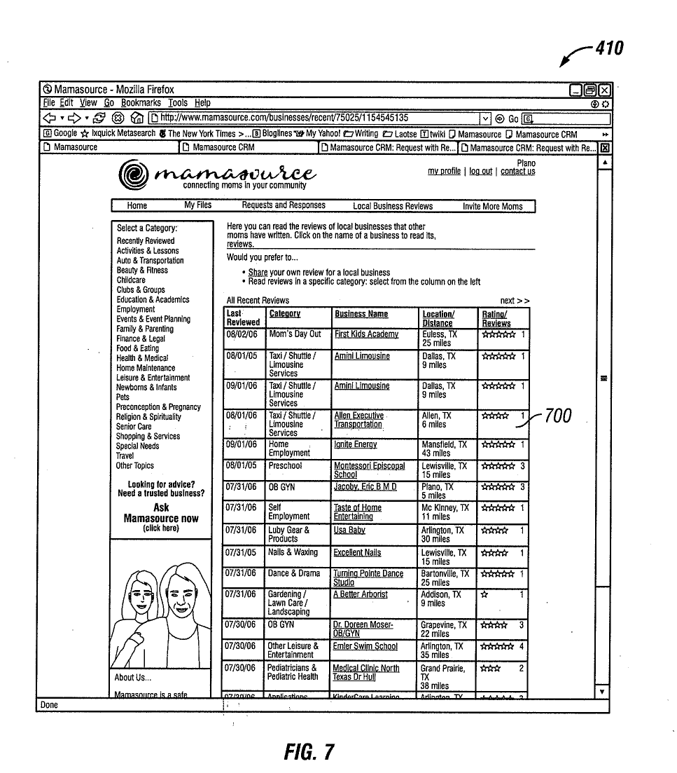

FIG. 6 is a screen shot of website for an ask/respond affinity group referral system showing an invitation to join the system 390. Because the system is based upon invitation only in this embodiment, it is important that moms invite other members of the community to join the system. As shown in FIG. 6, a mom can sends an invitation to another mom to join the community, and can also include a personal message.

A mom receiving the invitation may join the community by replying to the message she receives.

FIG. 7 is a screen shot of a website for an ask/respond affinity group referral system showing a portion of the shared directory 410 which comprises a listing for local businesses 700. In connection with this listing, a mom may either ask moms for referrals in this space or share their own information. The page also provides the hotels that are not rated in this case which may be rated by the mom when they are in the page to help build information about that particular hotel.

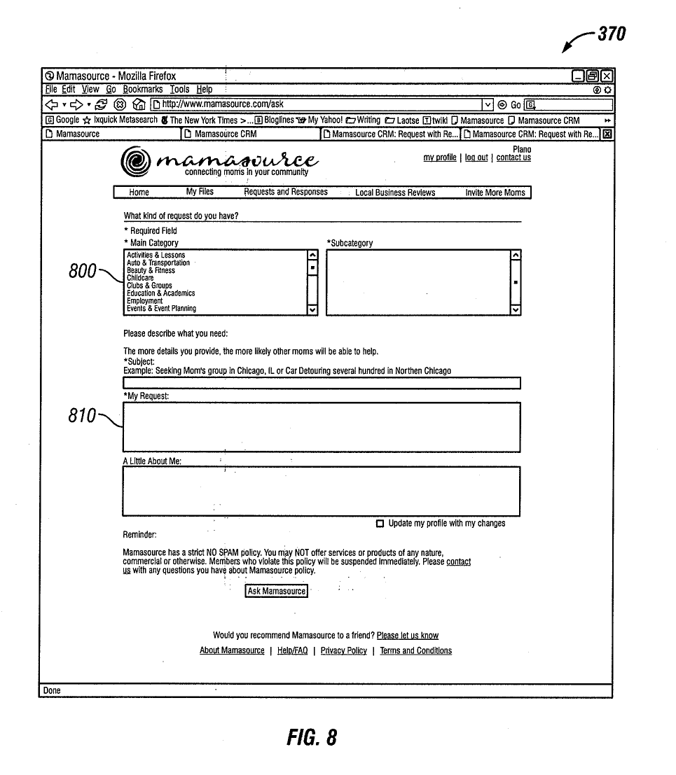

FIG. 8 is a screen show of a website for, in an ask/respond affinity group referral system showing an ask form 370 which this embodiment, is referred to as AskMamasource. The ask form provides a hierarchal scheme to allow a category of the request to be selected 800 and a portion for the person to describe the request 810. Note that the number of Mamasource moms in the area are identified. In this case 1387 other Mamasource moms are in the area of the referral.

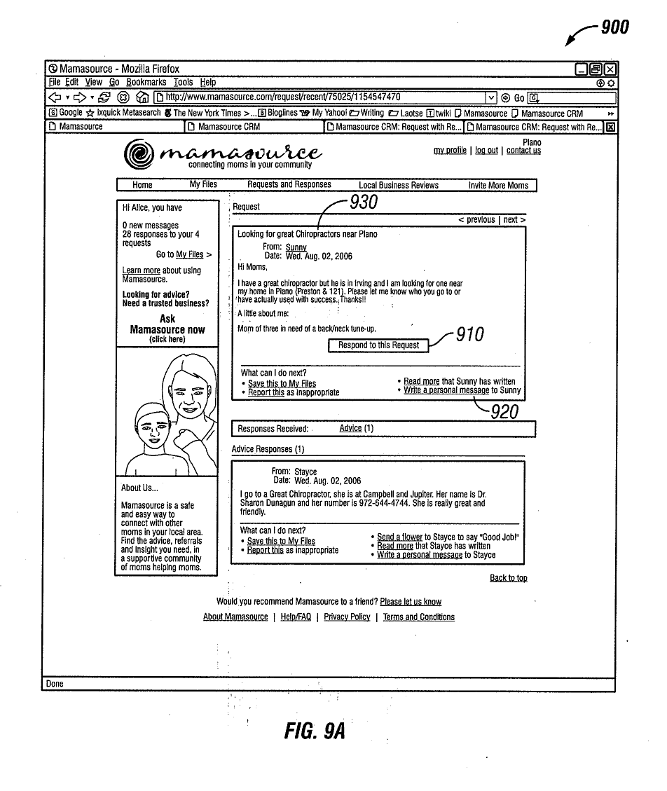

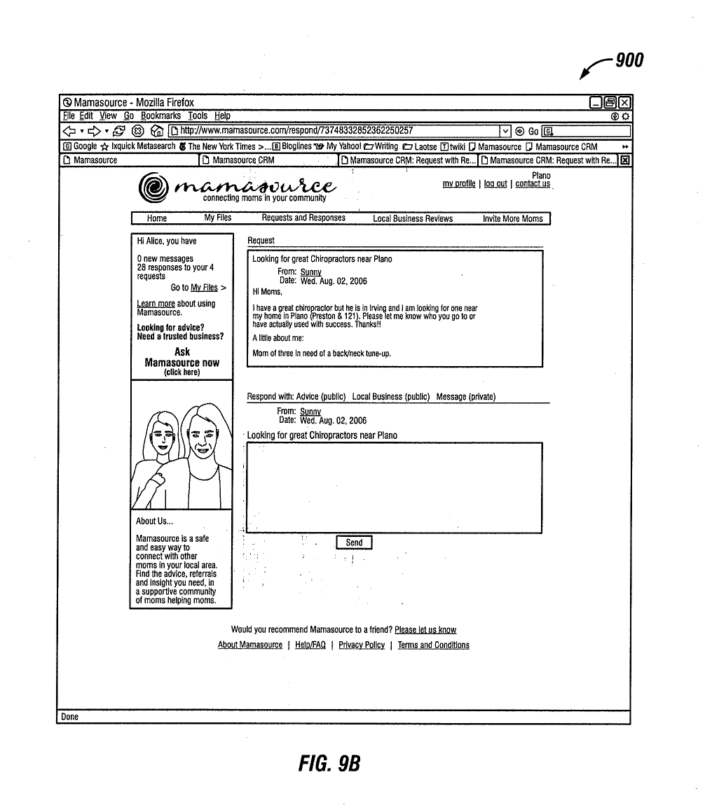

FIGS. 9a and 9b are screen shots of a website for an ask/respond affinity group referral system showing a form for responding to a request 900. In this case, a request added categories identified as chiropractors 930. The person receiving the request has the ability to respond with a referral 910 or to respond with a question or advice 920. This latter feature allows a response that is empathic or advisory.

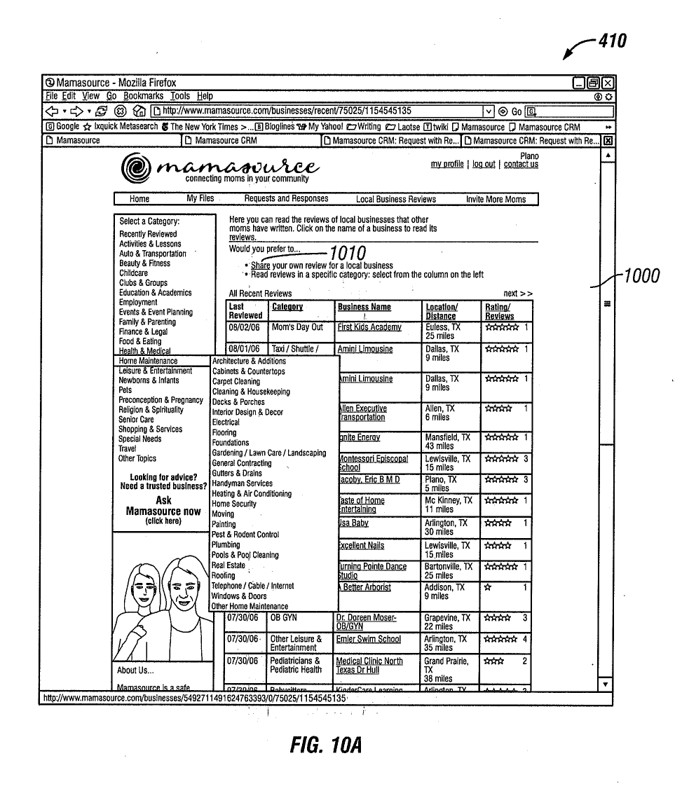

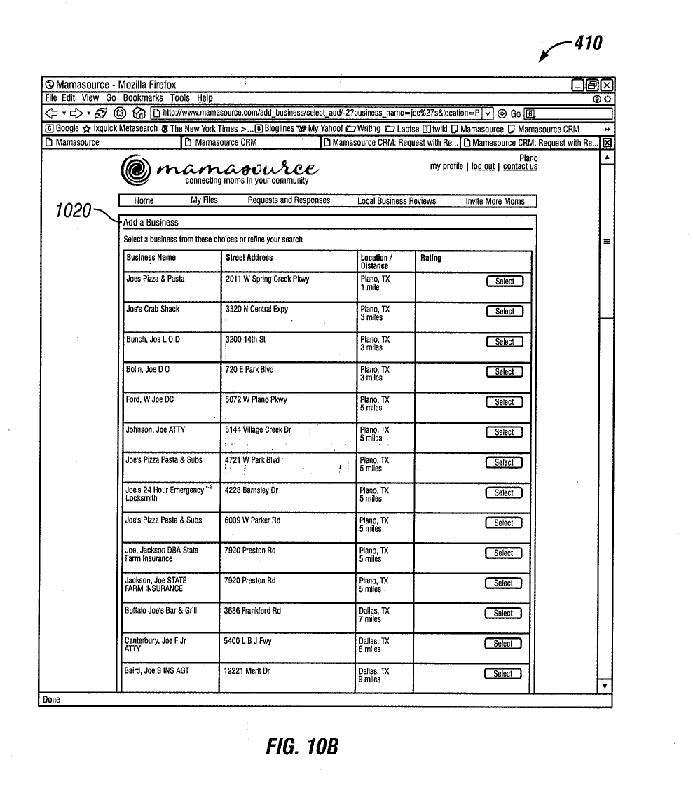

FIGS. 10a and 10b are screen shots of a website for an ask/respond affinity group referral system showing a shared directory 410. In this case a hierarchy is shown 1000 in which the different areas and categories in which advice or referrals may be obtained are identified. The user is provided with a button 1010 for sharing referrals by various regions, and for adding a business (FIG. 10b). In the example of FIG. 10, the referrals are shown in terms of local listings only.

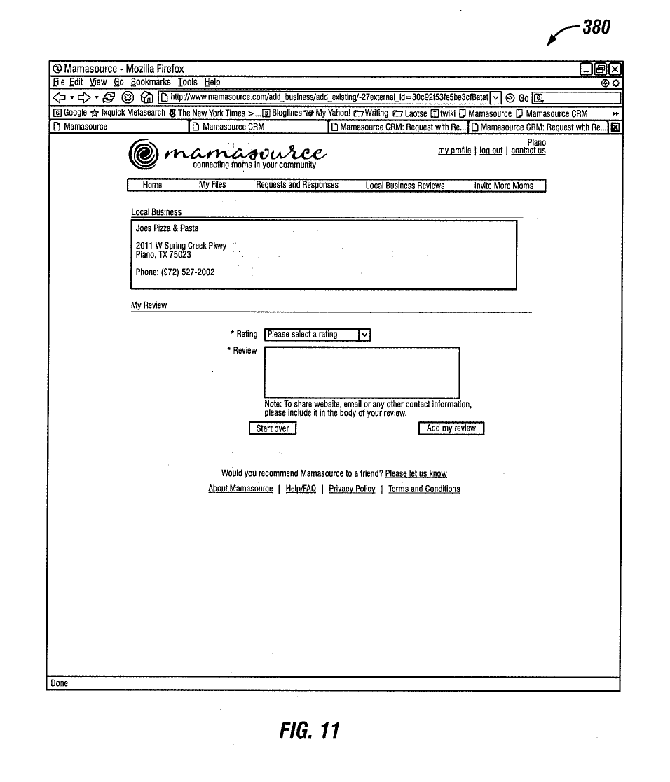

FIG. 11 is a screen shot of a website for an ask/respond affinity group referral system showing a share referral page 380. In this case the individual enters the name and location of the referral. The user can then add additional information through further screens.

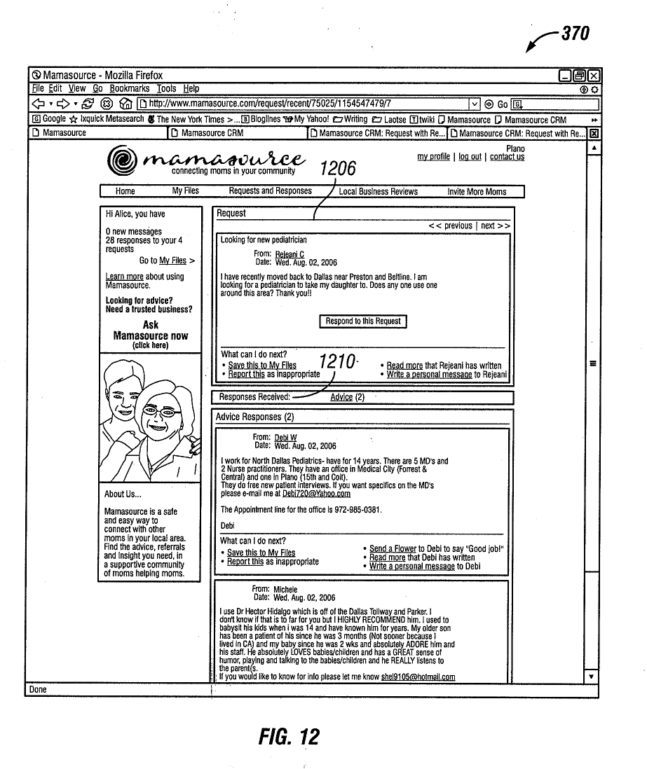

FIG. 12 is a screen shot of a website for an ask/respond affinity group referral system showing a request 370. The page provides a listing of the requests sent 1200 as well as a list of responses 1210.

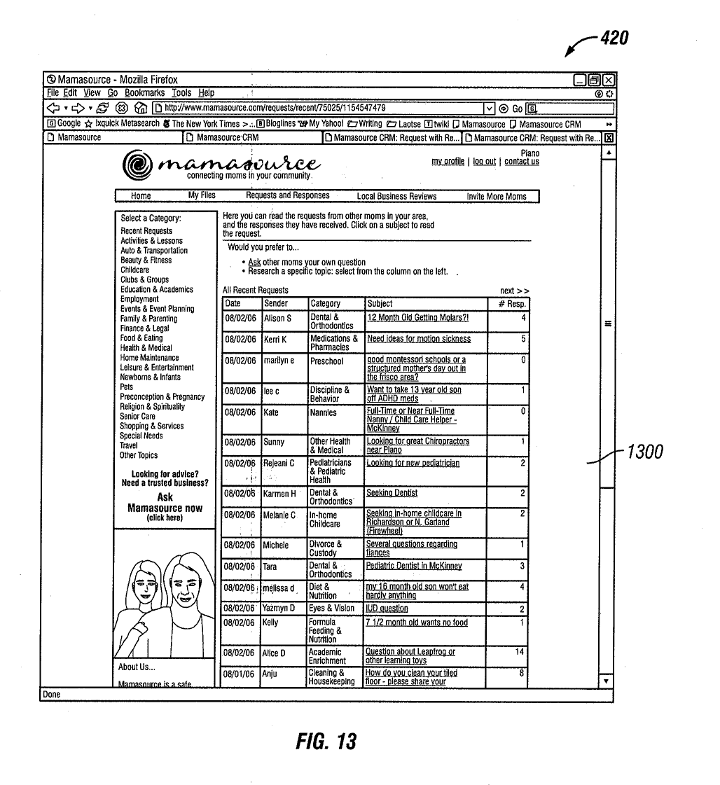

FIG. 13 is a screen shot of a website for an ask/respond affinity group referral service showing a list of past requests in a particular region 1300.

FIG. 14 is a screen shot of a website for an ask/respond affinity group referral system showing a member directory 360. In FIG. 14, the member directory is shown as a list 1400 of members in the area. The directory page also provides a listing of sent invitations 1410.

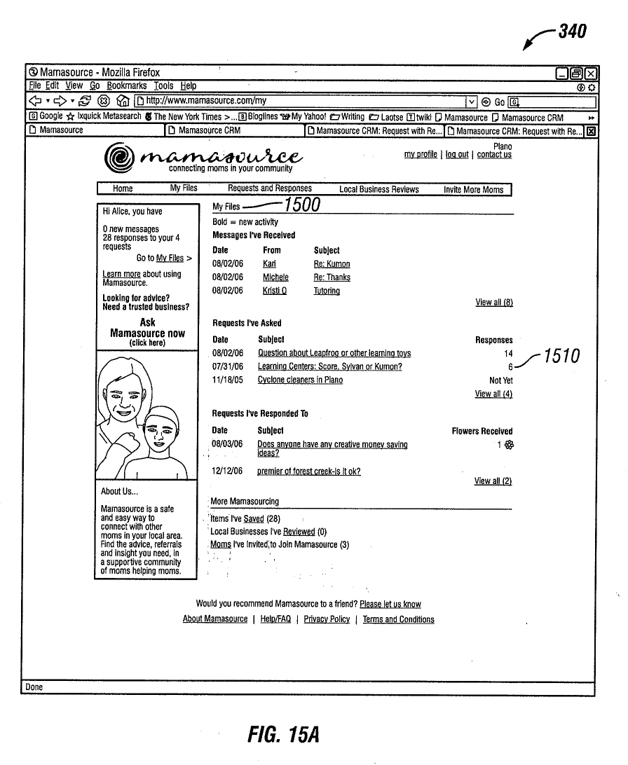

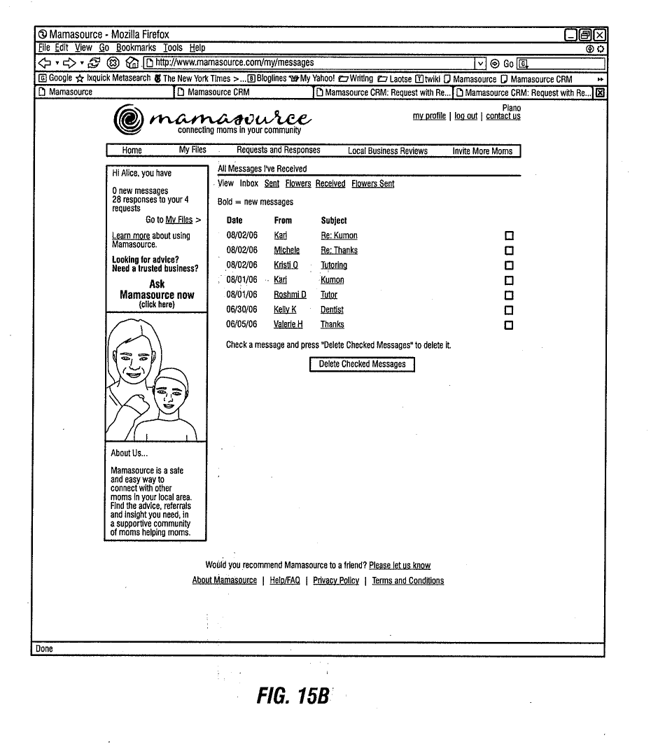

FIGS. 15a and 15b are screen shots of a website for an ask/respond affinity group referral system for an inbox 340 showing a list of sent requests 1510. The inbox folders are shown in the box in the upper left hand corner of the webpage 1500.

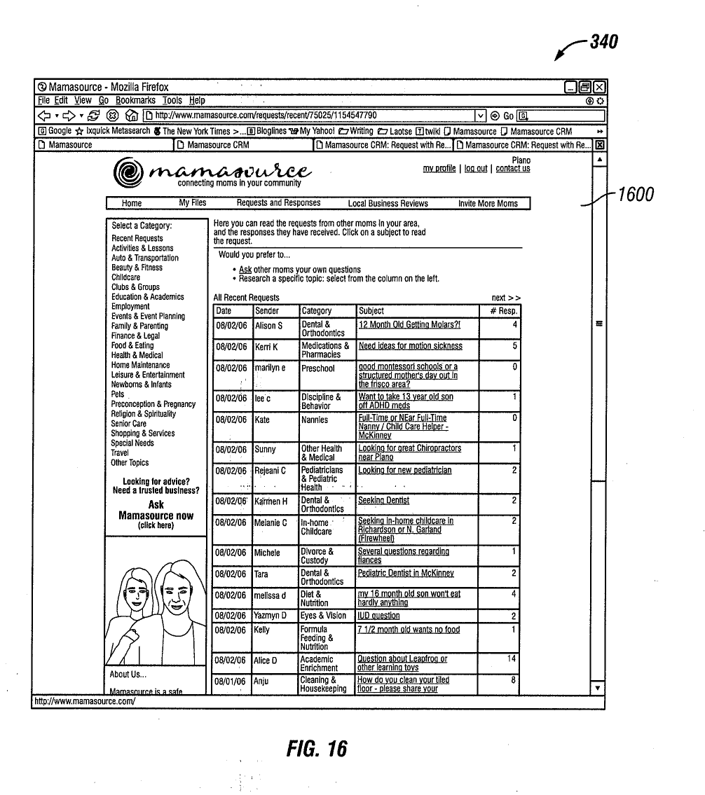

FIG. 16 is a screen shot of the website for an ask/respond affinity group referral system showing an inbox 340; in this case requests that have been in the inbox 1600.

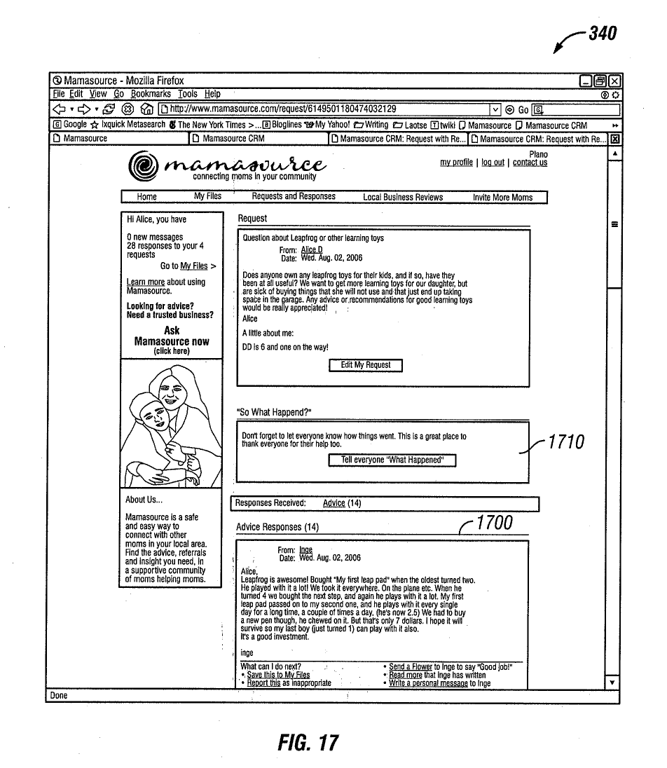

FIG. 17 is a screen shot of a website for an ask/respond affinity group referral system showing an inbox 340; in this example, a list of responses received 1700.

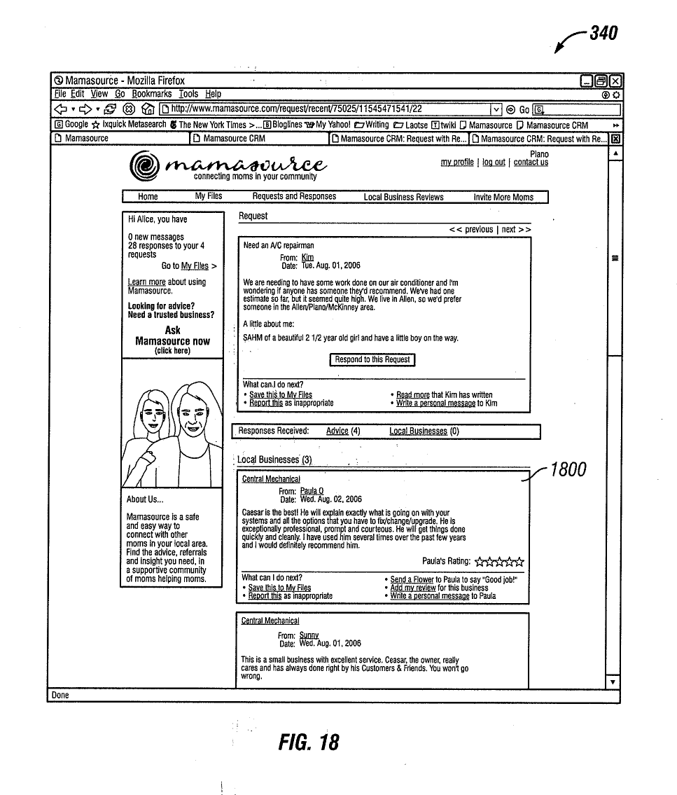

FIG. 18 is a screen shot of a website for an ask/respond affinity group referral system showing an inbox 340; in this example a listing of referrals 1800.

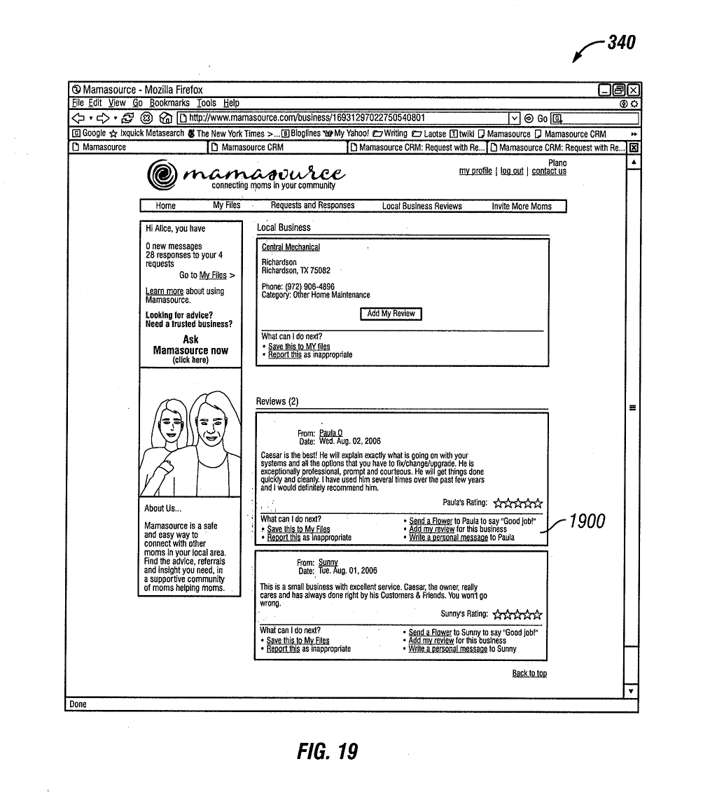

FIG. 19 is a screen shot of a website for an ask/respond affinity group referral system showing an inbox 340; in this example, actions with regards to various referrals 1900.

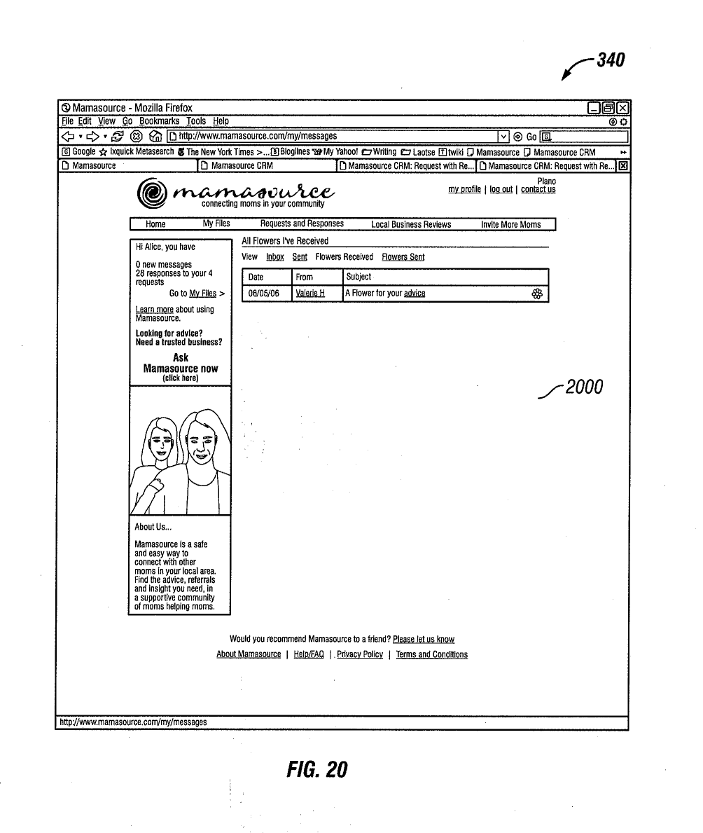

FIG. 20 is a screen shot of a website for an ask/respond affinity group referral system showing an inbox 340; in this example a listing of thank you notes, e.g. flowers, 2000.

FIG. 21 is a webpage showing a “so what happened” feature 1710.

Table 1 below provides a listing of help and user instructions which accompany the website provided in connection with the ask/respond affinity group referral system.

### Table 1

### Help and Instructions

### Help and Instructions

### 1. Getting the Basics

Why should I use Mamasource?
Mamasource makes it easy for moms to find the best local resources and services because:
   1. Mamasource offers a local community of moms like you who are actively sharing referrals and advice with one another.
   2. You get to ask a community of moms all at once, saving you time and energy.
   3. Other moms reply with referrals complete with ratings and comments. These are automatically organized and saved to your Shared Directory for you and other moms to reference easily.
   4. Using Mamasource is free and easy. Your Shared Directory grows naturally as you and other moms ask each other for recommendations. All you need to do is sign on and ask moms for their referrals and advice. Just like you do normally.
      Mamasource is private and free!
      Who should I contact if I have questions?
      Please contact the Mamasource customer service team at support@mamasource.com.

### 2. Inviting New Moms

Whom should I invite to Mamasource?
Mamasource is designed exclusively for moms. You can invite any mom whom you know well enough to ask for referral or advice. This could include moms you know through a mom's group, church/worship group or your child's school or activity group. You can feel free to ask for referrals on behalf of you non-mom friends and family, but we ask that you only invite moms to join the service.
How do I invite other moms to Mamasource?
All you need is the e-mail addresses of the moms you'd like to invite. There are two easy ways to invite other moms to join Mamasource.
   1. From My Homepage, go to Invite New Moms and follow the steps.
   2. By clicking here right now

### 3. Adding Listings

How do I find the category I'm looking for?
Go to the Shared Directory tab at the top, and browse to the category you are looking for, whether it's doctors, preschool, childcare, home improvement professionals or travel advice. If you don't find what you need from the current listings, click Ask Mamasource to send a request to the Mamasource community. You will be notified by e-mail when anyone has replied to your request. All replies will be saved in the Shared Directory for the next time anyone else might need the same information.
Go to the Shared Directory now.
If you are thrilled with a particular local business, share your experience on Mamasource by clicking any list to Share Referral when browsing the Shared Directory. You will be guided an through easy, step-by-step process to share your referral and Mamasource will even automatically look up the contact information for you! Other Mamasource Moms will then see your referral in the Shared Directory.
How do I add a listing?
From the shared directory, browse to the category you would like to enter a new listing in. Click Enter a Listing. Fill in the name, address phone number and e-mail address. Click Search Yellow Pages or ZIP Code Lookup if you need more information. Click “Preview” to see your listing, rate the listing, and add a comment, Then click “Save”.
What do the ratings mean?
Mamasource listings are rated by member moms on a scale of one to five (five being the highest). If a particular listing has multiple ratings from various moms, the rating you see is the average.
I can't find the category I'm looking for.
We'd love to hear your suggestions for categories you would like to add, or any feedback for that matter. Please send us an e-mail at feedback@mamasource.com.
Who can see my listings and recommendations?
Any rated listing or referral is saved in the Shared Directory and can be seen by the Mamasource community.
What if I think that a listing is inappropriate?
If you feel that a listing has errors, is a duplicate or doesn't fit in the particular category, click “Report Listing” and fill out the short form. Mamasource customer support will address the issue promptly.

### 4. Requesting Referrals

How do I ask other moms for referrals in a certain category?
From the Shared Directory tab, browse to the desired category. Click “Ask Mamasource” and follow the steps from there.

### Go to Ask Mamasource now.

How will I know when other moms have replied to my request?
Go to the “My Inbox” tab from the Home Page, and then click “My Requests”. Here you'll see all the active requests you have sent to the Mamasource community. Click on any request to see the responses you have received.

### Go to My Requests now.

How do I get more replies to my request?
After you send out a request, you can also forward the request to specific moms you know personally, but who are not yet Mamasource Moms. The more moms you forward your request to, the more likely you will reach a mom who can help you. These moms also get a private invitation to join the Mamasource community, so they will have access to the entire referral directory as well.
   Invite more Moms now.

### 5. Viewing My Profile

Who can see my profile?
By default, only you can see your full profile including your e-mail address. Mamasource will only make your e-mail address available to others (including other Mamasource members) with your consent. For more information, please read Mamasource Privacy Policy.
You can choose to allow other moms to view your full profile by changing your preferences under the “My Profile” tab on My Homepage.
How do I change something in my profile?
Go to the My Profile tab on your Homepage. Change any of the settings you would like, and then click “Update Profile”.

### Go to My Profile now.

### 6. Managing Requests

How do I reply to a request?
Go to My Inbox. You'll see a list of requests from fellow Mamasource Moms. Enter the listing you would like to send. You can either send a listing that is already in the Shared Directory or enter a new listing.

### Go to My Inbox now.

How can I stop someone from sending me messages?
If you would like to stop receiving messages from a Mamasource Mom, find the mom's profile in the Member Directory and click “Block”. Once you block a member mom, you will no longer see each other's requests. However, you will still be able to view each other's listings in the Shared Directory. When you block a users, they will not receive any e-mail or notification that you have done so. You can unlock a user at any time.

### 7. How Do I Send a Thank You?

You may want to send a Thank You Note to a mom who sent you a particularly great referral in response to your request. When you are viewing the mom's response, simply press the button to “Send Thank You Note” and type your thank you message.
   1. From the Home Page, go to “My Inbox” (link under the tabs).
   2. Once you are in “My Inbox”, these are all your messages from other Mamasource Moms. Some of these are “Replies” to things you have asked for. Click on the title if a reply to see it.
   3. Once you are looking at a reply at the bottom to “Send Thank You”

### 8. I Still Have More Questions

Please contact the Mamasource customer service team at support@mamasource.com.

In some embodiments of the invention, members of the ask/respond affinity group use an interactive timeline tool as a visual aid to record information about their children, to anticipate future child development needs, and to collaborate with other members of the ask/respond affinity group having similar parenting experiences.

In the presently preferred embodiments, the interactive timeline is a browser-based graphical user interface. According to these embodiments, members of the ask/respond affinity group use web tools to create personalized timelines for their living or unborn children by entering their child's birth date or date of conception into the user interface. After entering this basic information, a time axis of a timeline is initialized and a visual representation of the timeline is displayed to the user. Next, the user adds additional information into the timeline to memorialize important milestones in their child's life and memories of their child's development.

In addition to user-added milestones and memories, the timelines are also populated with topics posted by other members of the ask/respond affinity group, thereby capturing the extensive wisdom of the group. The timelines are individually-tailored for users by only displaying topics that are personally relevant to the user or that anticipate the user's questions and concerns throughout their child's developmental years. The personalized timelines also fulfill a user's desire to record memories and milestones as their children grow and thrive.

Preferably, the timeline are initially automatically centered on the age of the user's child. In some embodiments of the invention, users can scroll forward in time to get ready for what lies around the corner or backwards in time to look back upon their childcare journey so far. In some embodiments of the invention, the timeline displays community member-posted topics. In the presently preferred embodiments of the invention, the content of the community member-posted topics are customized to include only the information that is on a user's mind.

The timeline can be populated with any type information that is currently relevant to a user's child's development. As explained above, the timeline can be populated with community member-posted topics that are relevant to the current developmental concerns to the user's child. In some embodiments, the timeline can be populated with community member-recommended articles or websites relevant to a user's child's development. In some embodiments, the timeline can be populated with product recommendations and references for service professionals posted by community members, wherein only those recommendations that are likely to be needed by the user are displayed on the timeline. In the presently preferred embodiments of the invention, a crowd sourcing processing module is used to find relevant information from among all the community posted topics.

Likewise, in some embodiments of the invention, advertisements for businesses, services, products, et cetera are posted in the timeline. Preferably, advertisements are only posted if the advertiser is a trusted member of the ask/respond affinity community. In the presently preferred embodiments of the invention, users have the option of blocking any unwanted advertisement.

In some embodiments of the invention, the businesses that advertise using the ask/respond affinity group timeline interface have unique opportunities to reach consumers. For example, trusted businesses can post articles, shopping lists, and recipes that address specific community members' concerns. These businesses are able to reach users during the targeted time period when one or more particular needs are almost certain to be on a user's mind based on the child's age, the season, the location, et cetera.

For example, a party-planning business can post an article with tips for holding a fun birthday party, wherein the article will appear on a user's timeline around the time of the user's child's birthday. Likewise, an office supply store can publish a back-to-school shopping list for various age groups, wherein the article will appear to users with school-aged children in the fall.

According to these examples, the businesses help inform parents and help get the users organized, while also getting out their brand identity to users who are highly likely to be influenced by the advertisements in the articles. In some other embodiments, trusted businesses can have their brand content featured in weekly emails generated by a ask/respond affinity group website, featured in an advertisement in a mobile application platform that delivers the timelines, or featured as a sponsor of a notification that is sent out to one or more member of the ask/respond affinity group (explained below).

As discussed below, a plurality of interactive timeline interface types are contemplated by this invention. In some embodiments, the timeline interfaces have one or more windows for displaying representations of a timeline, windows for plotting milestones and memories, windows for plotting age-related community member-posted topics, articles, advertisements, et cetera, and windows for showing one or more issues relating to a current point of child development corresponding to the timeline. It will be readily apparent to those with ordinary skill in the art having the benefit of this disclosure that any number of practical, stylistic, or ornamental features can be used in the timelines in addition to those explicitly disclosed. For example, in some embodiments of the invention, the appearance of the timeline changes with the season, i.e. an outdoor activity motif during the summer and a holiday motif during the winter.

In the presently preferred embodiments of the invention, the interactive timelines are accessed by users of the ask/respond affinity group via a browser-based graphical user interface. In some other embodiments, the timelines are accessed via a standalone software application, an application running on a mobile device, among other delivery options that will be apparent to those having ordinary skill in the art. In some other embodiments of the invention, the timelines can be shared with other applications, social media websites, blogs, et cetera.

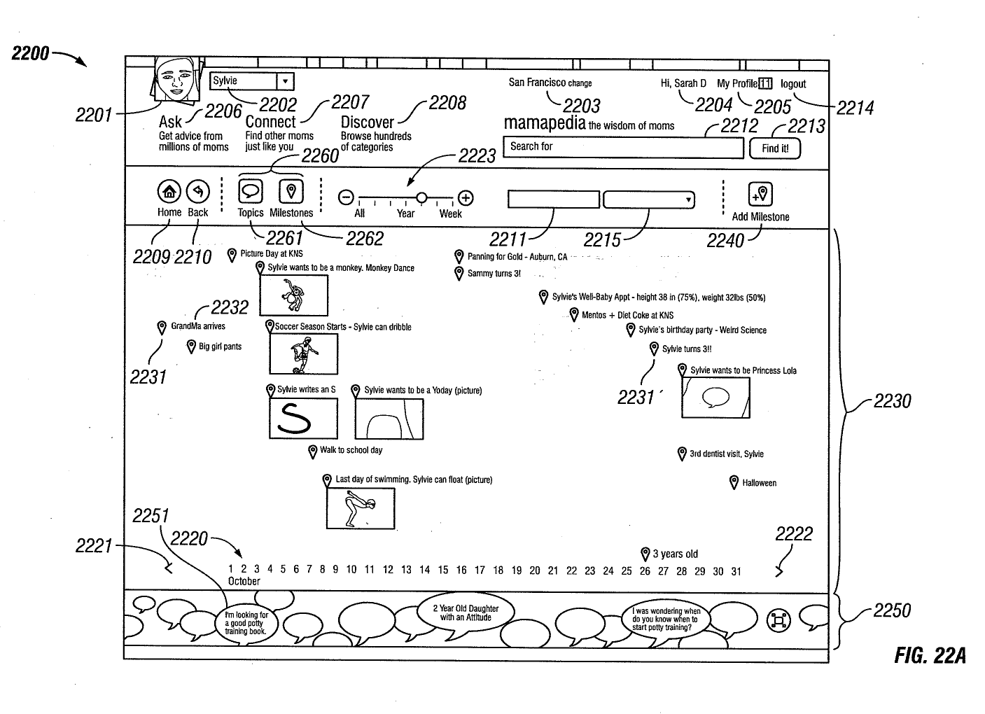

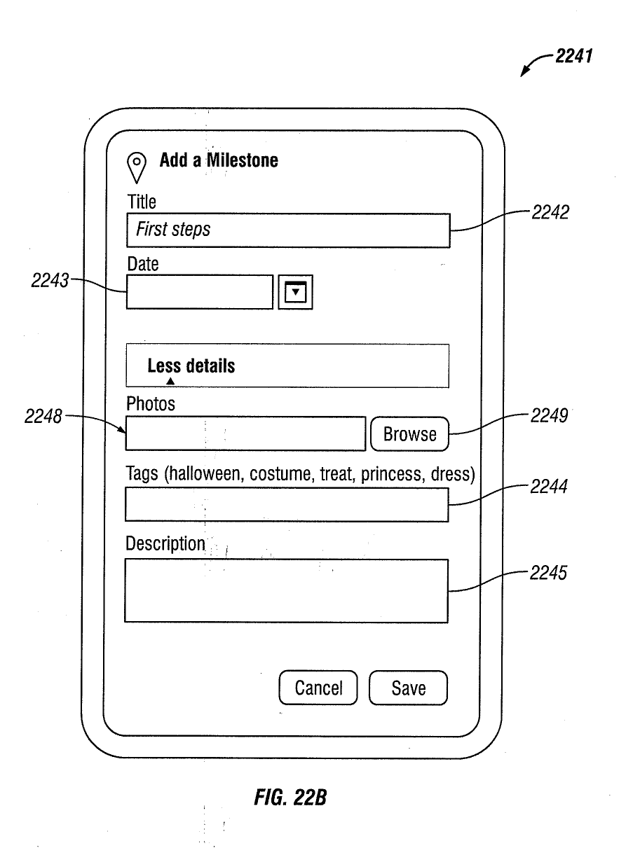

FIG. 22A is a representation of an interactive timeline interface 2200 populated with milestones for the child of user. The interactive timeline interface 2200 includes a representation of a timeline 2220 centered on the present age of the user's child. As shown, the timeline 2220 shows a one-month window, i.e. October 1 through October 31. The timeline 2220 includes a pair of terminal arrow tools 2221, 2222 for navigating to an earlier time frame or advancing to a later-occurring or future time frame. Additionally, the interactive timeline interface 2200 includes an adjustable scale tool 2223 for changing the time-scale of the timeline 2220, i.e. weekly scale, monthly scale, quarterly scale, yearly scale, lifetime scale, et cetera.

The timeline interface 2200 includes a main window 2230 that is segmented in time according to the current scale of the timeline 2220. The main window 2230 includes a plurality of milestone markers 2231 plotted in time across the main window 2230. Milestone markers are used to memorialize events, memories, accomplishments, and other data. Examples of such milestones include birthdays, dates of vaccination, holidays, school achievements, fond memories, travel plans, et cetera. It will be readily apparent to those with ordinary skill in the art having the benefit of this disclosure that any type of milestone can be added to the timeline interface 2200.

In the preferred embodiments of the invention, the milestone markers 2231 include at least a text box 2232 describing the milestone. In some embodiments, the milestone markers 2231 can include pictures, videos, sound clips, hyperlinks, et cetera, that provide even more information about the event.

The timeline interface 2200 includes a radio button 2240 for adding new milestones. In some embodiments of the invention, pressing the radio button 2240 causes a pop-up window to appear for adding new milestones. FIG. 22B is a representation of a pop-up window 2241 for adding a new milestone according to some embodiments of the invention. The pop-up window 2241 includes fields 2242 and 2243 for entering text to describe the milestones and to record the date of the milestone. The pop-up window 2241 also includes a photo upload tool 2249 and interface 2248. Likewise, the pop-up window 2241 includes fields 2244, 2245 for entering text to describe the uploaded photos.

Referring again to FIG. 22A, the timeline interface 2200 includes an ancillary window 2250 for displaying additional information. As explained above, the timeline can be populated with community member-posted topics, product/service recommendations, advertisements, et cetera. As shown, the ancillary window 2250 includes a plurality of community member-posted topics 2251. The community member posted topics 2251 include topics that are relevant to needs of the user's child at particular time indicated on the timeline.

For example, the main window 2230 includes a milestone marker 2231′ indicating that the user's daughter turns three-years-old. According to this example, the community member posted topics 2251 include only the topics relevant to a three-year-old girl, i.e. bed-wetting. Likewise, the timeline 2220 indicates that the current month is October, and therefore the community member-posted topics 2251 can include topics relating to creative Halloween outfit ideas.

The interactive timeline interface 2200 also includes one or more toggle buttons 2260 for toggling between windows. For example, a “Topics” button 2261 causes the main window 2230 to display the community member-posted topics 2251 and causes the ancillary window 2250 to display the milestones 2231. Likewise, a “Milestones” button 2262 causes the main window 2230 to display the milestones 2231 and causes the ancillary window 2250 to display the community member-posted topics 2251.

Additionally, the interactive timeline interface 2200 contains icons 2201 and dialog boxes 2202, 2203, 2204 that indicate user identification, geographic, and other demographic information. The interactive timeline interface 2200 includes tools 2205, 2206, 2207, and 2208 for changing user profile information, asking other users advice, connecting with other users having similar interests and needs, and browsing categories of relevant information. Likewise, the interactive timeline interface 2200 includes various other navigation tools 2214, 2209, 2210 and search tools 2212, 2213, 2211, 2215.

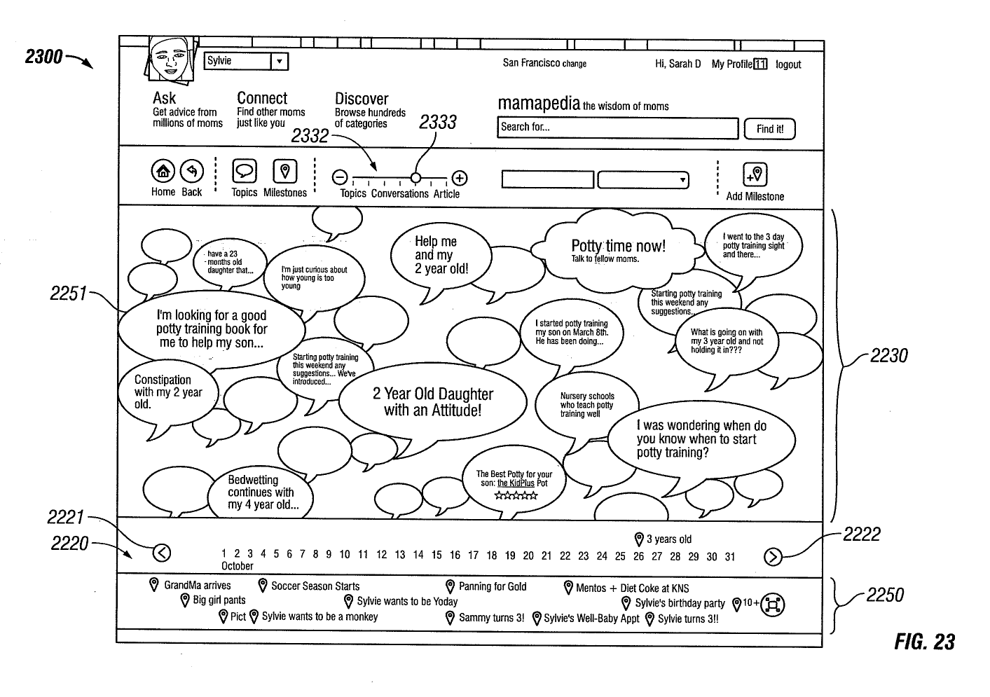

FIG. 23 is a representation of an interactive timeline interface 2300 populated with community member-posted topics 2251 relevant to a user's child according to some embodiments of the invention. FIG. 23 is an example of an interactive timeline interface 2300 that has been toggled from the interface 2200 of FIG. 22A. In fact, the interactive timeline interface 2300 includes the timeline 2220 having the same time-scale. Likewise, the interactive timeline interface 2300 includes profile settings, navigation, and searching tools as those described in the discussion of FIG. 22, above. Additionally, the interactive timeline interface 2300 includes a plurality of community member-posted topics 2251.

In some embodiments of the invention, the interactive timeline interface 2300 includes a slider 2332 for changing the types of information displayed in the main window 2230. As show, the track ball 2333 of the slider 2332 is positioned such that detailed community member-posted topics 2251 are displayed. In some embodiments, sliding the track ball 2333 of the slider 2332 left-hand side causes the main window 2230 to display more basic topic types and sliding the track ball 2333 to the far right of the slider 2332 causes the main window 2230 to display in-depth articles.

In some other embodiments of the invention, the main window can be populated with product/service recommendations and advertisements for businesses, services, products, et cetera.

As explained above, the timeline 2220 includes a pair of terminal arrow tools 2221, 2222 for navigating to an earlier time frame or advancing to a later-occurring or future time frame. In the presently preferred embodiment of the invention, the interactive timeline interface 2300 is used to look forward in time to anticipate issues that will occur in the user's child's future so that the user can plan for them.

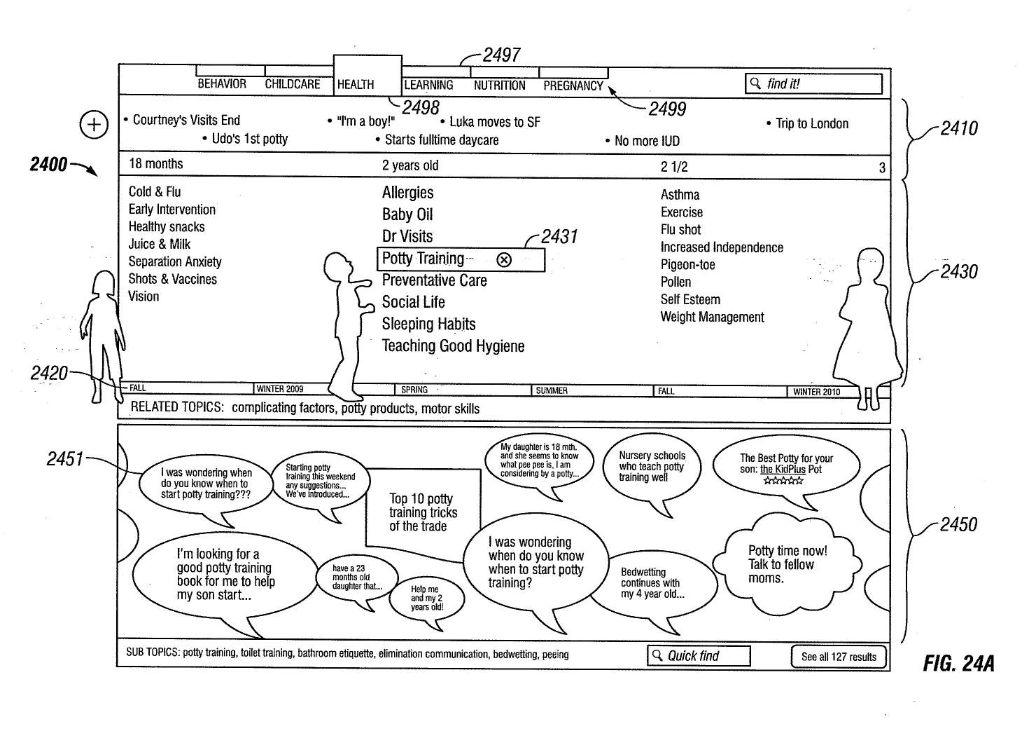

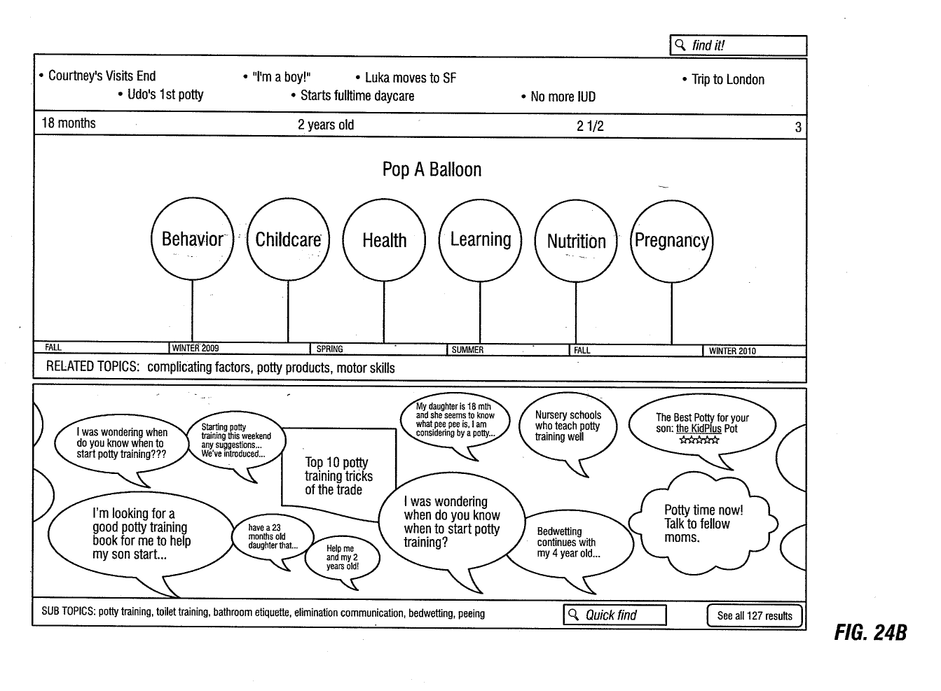

In some embodiments of the invention, the interactive timeline interface includes a topical menu to select common issues to research. FIG. 24A is a representation of an alternative interactive timeline interface 2400 with a plurality of menus and windows for navigating common issues relating to child development according to some embodiments of the invention.

The interactive timeline interface 2400 includes an issue menu 2499, a timeline 2420, an issue window 2430 listing common aged-related sub-issues 2431, a community-posted topic window 2450 showing community-posted topics 2451 relating to one or more sub-issue 2431, and a milestone window 2410. In the presently preferred embodiments of the invention, when a user enters information about their child and chooses an issue or sub-issue they want to examiner, the timeline 2420 is automatically populated with community member-posted topics relating to those issues that are also temporally relevant to the user's child's current stage of development.

For example, FIG. 24A shows a menu 2499 for populating the issue window 2430 with various issues relating to a user's child's development between eighteen months old and three years old. As shown, a user selects the “HEALTH” tab 2498 to navigate only sub-issues 2431 about his child's health. Additionally, the community-posted topic window 2450 includes a plurality of community member-posted topics 2451, articles, or advertisements relating to the currently selected tab from the menu 2499 or relating to the currently-selected sub-issue 2431.

In some embodiments of the invention, the user can advance the timeline 2420 to research future health-related issues. For example, a parent of a three-year-old girl might want to anticipate what the expected health needs for his daughter will be during the upcoming year. According to this example, the timeline 2420 can be advanced and the issue window 2430 can be re-populated show sub issues 2431 relating health issues of three and one-half year olds, i.e. immunization booster shots. Additionally, the community-posted topic window 2450 can include an article written about the pros and cons of certain controversial immunizations. Likewise, the community-posted topic window 2450 can include community member reviews of local doctors or health care facilities that administer booster shots.

In another example, a user can select the “LEARNING” tab 2497 to change the presently-displayed issues and can advance the timeline 2420 by a year to see what kind of learning issues will arise during the next of the user's child's development. According to this example, the user might see community member-posted topics 2451 suggesting that parents of three-year-olds begin considering elementary schools. The user can review community member-posted topics 2451 relating to local elementary schools posted by parents with children currently attending those schools or posted by parents who are also just beginning to consider elementary school. Additionally, the user might also see suggestions or reviews for books for a four year old to read to help prepare them for elementary school. Likewise, a community-endorsed learning center can place advertisements for useful pre-elementary school preparation programs on the timeline 2220.

In some embodiments, a user can advance the timeline 2420 far in advance to research local high schools in their school district, to review topics relating to the future cost or admission standards of nearby colleges, or to perform other long-term planning research. Although specific examples of parenting research are set forth herein, it will readily apparent to those with ordinary skill in the art that a wide variety of parenting information can be accessed in a similar manner as discussed herein.

As discussed above, a plurality of interactive timeline interface types are contemplated by this invention including timeline having any number of practical, stylistic, or ornamental features. As another example, in some embodiments of the invention, the timeline interface includes an issue-selection interface with balloon icons that display issue types. According to these embodiments, individual balloons are “popped” by a mouse-click, thereby selecting the issue.

FIG. 24B is a representation of an alternative interactive timeline interface with a topical balloon menu for navigating common issues relating to child development according to some embodiments of the invention.

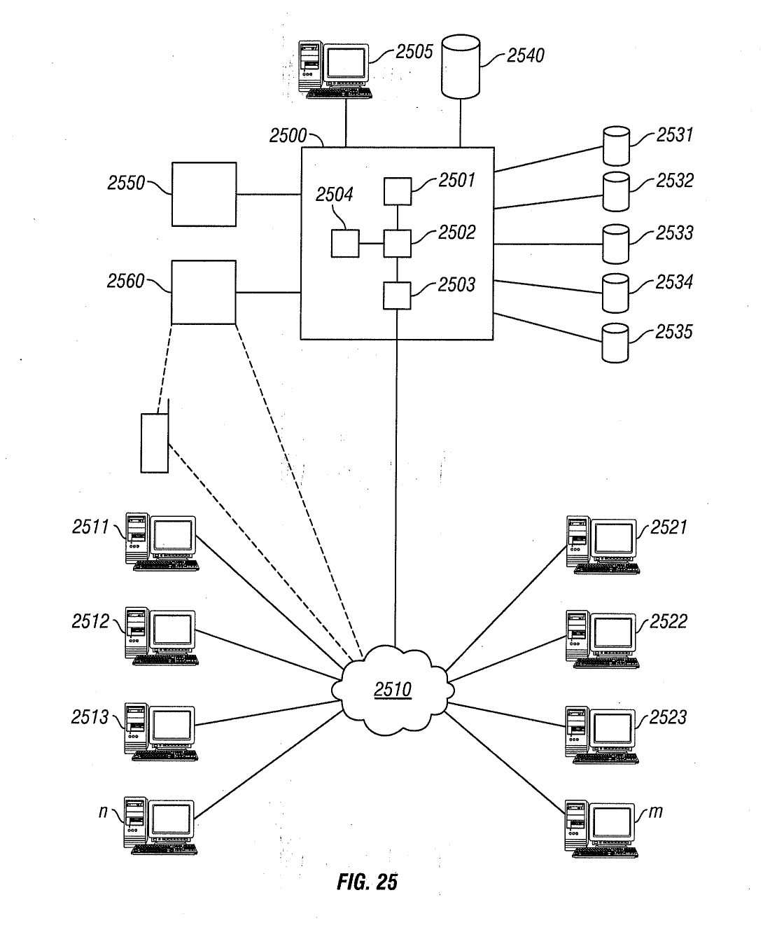

In the presently preferred embodiment of the invention, a central processing engine generates, populates, and delivers interactive timelines to a plurality of users within the ask/respond affinity group via a network. FIG. 25 illustrates a schematic representation of a timeline manager 2500 for providing an ask/respond affinity group with timeline services over a distributed network according to some embodiments of the invention.

The timeline manager 2500 comprises a processor 2502 coupled with memory 2501 and with a network interface 2503. Additionally, the processor 2502 is coupled to a clock 2504 that is used to provide temporal data for timeline generation. In some embodiments of the invention, the timeline manager 2500 is coupled with an administrative computer 2505.

The timeline manager 2500 generates a plurality of timelines by obtaining information from a plurality of sources including user information from a plurality of members of the ask/respond affinity group; historic data previously posted by members of ask/respond affinity group, and information from businesses, among other sources. In the presently preferred embodiment of the invention, the timeline manager is connected to the various sources via a computer network 2510. The network 2510 is connected to a plurality of user computers 2511, 2512, 2513, . . . n, as well as a plurality of business user computers 2521, 2522, 2523, . . . m.

In some embodiments of the invention, the gathered information is stored in one or more database including a user information database 2531, a topic database 2532, an article database 2533, a vender information database 2534, or a service provider database 2535.

Using the gathered information, the timeline manager 2500 generates and delivers timelines for the plurality of users. In some embodiments of the invention, the timeline manager 2500 is coupled to a crowd sourcing module 2550. The crowd sourcing module 2550 ingests and analyzes the gathered data to identify information that is relevant to users based on the age of their children, gender of their children, special needs of the children, time of year, user's profile, et cetera. Information that is deemed relevant to a user becomes candidate information for inclusion in the user's timeline. In some embodiments of the invention, the timeline manager 2500 is coupled to a timeline storage database 2540 for short- or long-term storage of generated timelines.

In some embodiments of the invention, the timeline manager 2500 is coupled with a notification module 2560. The notification module 2560 accesses the timeline storage database 2540 and analyses the timelines stored therein. The notification module 2560 then provides alerts to users to remind them when important events are scheduled to occur. In some embodiments of the invention, the notification module 2560 sends notifications to the user's computer. In some other embodiments, the notification module 2560 sends notifications to a user's mobile device 2561. In some embodiments, the notification module 2560 sends wireless notifications directly to the mobile device 2561. In some other embodiments, the notification module 2560 sends notifications to the mobile device 2561 by routing the notifications through the network 2510.

Although the invention is described herein with reference to the preferred embodiment, one skilled in the art will readily appreciate that other applications may be substituted for those set forth herein without departing from the spirit and scope of the invention. Accordingly, the invention should only be limited by the Claims included below.

1. A computer system for providing interactive timelines to a plurality of members of an ask/respond affinity group comprising:
a server-based ask/respond affinity group web-space processor configured to connect a plurality of members with common parenting issues over a computer network, wherein said plurality of members interact via a common web-space, and wherein said web-space comprises:
tools configured for asking questions relating to parenting; and
tools configured for posting answers to said questions in the form of community member-posted topics;
a timeline manager processing module coupled to said ask/respond affinity group web-space processor, said timeline manager configured for managing an interactive timeline application, wherein said interactive timeline application is configured to be displayed on a plurality of member computers and a plurality of business computers, wherein said plurality of member computers are operated by members of said ask/respond affinity group, and wherein said plurality of business computers are operated by businesses to offer goods and services to said members of said ask/respond affinity group;
wherein said timeline manager processing module is configured to:
gather data about members' children from said plurality of member computers, said data comprising at least a temporal element;
generate a plurality of personalized interactive timelines based on said data, wherein said plurality of personalized interactive timelines are initially centered on a point in time relating to said temporal element; and
responsive to member questions relating to parenting, populate said plurality of personalized interactive timelines with said community member-posted topics relating to both said questions and said temporal element; and
send said plurality of personalized interactive timelines to said plurality of member computers for display.

2. The computer system of claim 1, wherein said data about members' children comprises any of information relating to milestones in the development of said children, memories from raising said children entered by said members, health information of said children, and combinations thereof.

3. The computer system of claim 1, further comprising:
at least one timeline storage database coupled to said server-based ask/respond affinity group web-space processor for storing said plurality of personalized interactive timelines.

4. The computer system of claim 1, wherein said timeline manager processing module further populates said plurality of personalized interactive timelines with community member-posted topics relating to said data about members' children and relating to a time in the future, wherein the timeline manager processing module analyzes said data about members' children and said temporal element and predicts what issues may affect said children in the future.

5. The computer system of claim 1, wherein said personalized interactive timelines include a means for entering additional child data into said personalized interactive timelines.

6. The computer system of claim 1, wherein said timeline manager processing module further comprises:
a crowd-sourcing module used to populate at least one individual member's personalized interactive timeline with said community member-posted topics relating to both said questions and said temporal element, wherein said crowd-souring module is configured to:
asking questions relating to parenting; and
tools configured for posting answers to said questions in the form of community member-posted topics;
analyze said questions relating to parenting;
match said questions relating to parenting to community member-posted topics; and
populate said plurality of personalized interactive timelines with community member-posted topics that match said questions relating to parenting.

7. The computer system of claim 6, wherein said web-space includes a means for said businesses to post one or more advertisements for goods and services relating to parenting, and wherein the crowd-sourcing module is further configured to:
analyze and categorize said one or more advertisements;
match questions relating to parenting to a category of advertisements thereby identifying one or more useful goods or services; and
populate said plurality of personalized interactive timelines with said advertisements for said useful goods or services.

8. The computer system of claim 1, wherein said personalized interactive timelines include a means for entering future events into said personalized interactive timelines.

9. The computer system of claim 8, further comprising a notification module for alerting individual members when said future events are about to occur.

10. A computer-implemented system for providing interactive timelines to a plurality of members of an ask/respond affinity group comprising:
connecting a plurality of members of an ask/respond affinity group web-space via a common server-based processor, wherein said web space includes a tools for asking questions relating to parenting and tools for posting answers to said questions in the form of community member-posted topics;
obtaining data from said plurality of members relating to their children, wherein said data at least includes a temporal element;
generating a plurality of personalized interactive timelines based on said data, wherein said plurality of personalized interactive timelines are initially centered on a point relating to said temporal element;
populating said plurality of personalized interactive timelines with additional information derived from said member questions relating to parenting, said community member-posted topics, and said said temporal element; and
sending said plurality of personalized interactive timelines to said plurality of member computers for display.

11. The computer-implemented system of claim 10, wherein said data about members' children further comprises any of information relating to milestones in the development of said children, memories from raising said children entered by said members, health information of said children, and combinations thereof.

12. The computer-implemented system of claim 10, further comprising storing said plurality of personalized interactive timelines in at least one timeline storage database coupled to said common server-based processor.

13. The computer-implemented system of claim 10, further comprising populating said plurality of personalized interactive timeline with future events, wherein said future events are created by analyzing said data about members' children and predicting what issues may affect said children in the future using said timeline manager.

14. The computer-implemented system of claim 10, further comprising entering additional child data into said personalized interactive timelines.

15. The computer-implemented system of claim 10, further comprising populating at least one individual member's personalized interactive timeline with topics of interest using a crowd-sourcing module by performing the steps of:
analyzing said topics relating to parenting;
matching said topics relating to parenting to said individual member's questions relating to parenting thereby identifying one or more relevant topics; and
populating said individual member's personalized interactive timeline with said one or more relevant topics.

16. The computer-implemented system of claim 15, wherein said web portal includes a means for said businesses to post one or more advertisements for goods and services relating to parenting, and wherein the crowd-sourcing module further performs the steps of:
analyzing and categorizing said one or more advertisements;
matching said individual member's questions relating to parenting to a category of advertisements thereby identifying one or more useful goods or services; and
populating said individual member's personalized interactive timeline with said advertisements for said useful goods or services.

17. The computer-implemented system of claim 10, further comprising said members populating said personalized interactive timelines with one or more future events.

18. The computer-implemented system of claim 17, further comprising alerting individual members when said future events are about to occur using a notification module.
